(19) United States
(12) Patent Application Publication
(10) Pub. No.: US 2017/0220050 A1
(43) Pub. Date: Aug. 3, 2017

(54) FLOW REGIME IDENTIFICATION APPARATUS, METHODS, AND SYSTEMS

(71) Applicant: LANDMARK GRAPHICS CORPORATION, Houston, TX (US)

(72) Inventors: Florentina POPA, Houston, TX (US); Brent Charles HOUCHENS, Houston, TX (US); Andrey FILIPPOV, Houston, TX (US)

(21) Appl. No.: 15/514,795

(22) PCT Filed: Oct. 22, 2014
(86) PCT No.: PCT/US2014/061767

§ 371 Date: Mar. 27, 2017

(51) Int. Cl. G05D 7/06; G06F 17/50; G05B 19/048

(52) U.S. Cl. CPC G05D 7/0617; G05B 19/048; G06F 17/5009; G05B 2219/24015

(57) ABSTRACT

In some embodiments, an apparatus and a system, as well as a method and article, may operate to determine proximity to fluid flow regime transition zones at a location in an internal fluid flow based on weighting function values in a continuous parameter space associated with the location, and physical parameter values associated with the fluid flow at the location that are determined by at least one of measurement or simulation. Further activity may include operating a controlled device based on the proximity to a selected one of fluid flow regimes defined by the fluid flow regime transition zones. Additional apparatus, systems, and methods are disclosed.

### BACKGROUND

Understanding the structure and properties of the physical world can reduce the cost of operations on the factory floor, and in the field. For example, knowing the characteristics of geological formations can lessen the cost of drilling wells for oil and gas exploration. Measurements made in a borehole (i.e., downhole measurements) are typically performed to attain this understanding, to identify the composition and distribution of material that surrounds the measurement device downhole. Sometimes this material is present in more than one phase, such as liquid and gas, or fluid of one composition, and fluid of another composition.

The state in which a multiphase system exists may be defined by multiple regimes. The regime in which the system exists is determined by a set of fundamental, independent parameters, which are continuous by definition, within the space. Each regime may be further described by one or more descriptive parameters, functions, data sets and/or empirical correlations, some of which may provide useful insight into the behavior of the system, but which are not necessarily part of the fundamental, independent parameter space.

In some cases, at the transition between regimes, these descriptive parameters, functions, data sets and/or empirical correlations exhibit discontinuities, which might be relatively abrupt. For example, nonphysical oscillation between two regimes can delay or even completely disrupt convergence in a numerical simulator or a control system, presenting numerical difficulties in the simulator, and erratic action in the control system.

### BRIEF DESCRIPTION OF THE DRAWINGS

FIG. 1 is a flow diagram of regime-based discontinuity smoothing methods, according to various embodiments of the invention.

FIG. 2 is a map in two-dimensional, regime-based parameter space, of four regimes (1, 2, 3 and 4) with descriptive parameters p₁, p₂, p₃ and p₄, according to various embodiments of the invention.

FIG. 3 is a three-dimensional map of normalized and restructured regime transition functions, according to various embodiments of the invention.

FIG. 4 illustrates three intermediate regime-based smoothing functions for regime 1, with descriptive parameter p₁, of FIG. 2, according to various embodiments of the invention.

FIG. 5 illustrates a scaled regime weighting function for regime 1, with descriptive parameter p₁, of FIG. 2, according to various embodiments of the invention.

FIG. 6 is a composite surface plot of all scaled regime weighting functions for regimes 1, 2, 3 and 4, with descriptive parameters p₁, p₂, p₃ and p₄, according to various embodiments of the invention.

FIG. 7 illustrates the location of three slices taken at constant x-axis values within the regime-based parameter space of FIG. 2, according to various embodiments of the invention.

FIGS. 8-10 illustrate the original and smoothed descriptive parameter/function values for each slice taken in FIG. 7, respectively, according to various embodiments of the invention.

FIG. 11 sets forth a series of mechanistic regime transition functions, according to various embodiments of the invention.

FIG. 12 is a flow diagram of a regime identification method, according to various embodiments of the invention.

FIG. 13 is a map in two-dimensional, regime-based parameter space, of multiple regimes, according to various embodiments of the invention.

FIG. 14 illustrates the original and smoothed values for pressure drop across the regimes of FIG. 13, according to various embodiments of the invention.

FIG. 15 illustrates a control apparatus, and a control system according to various embodiments of the invention.

FIG. 16 is a flow diagram illustrating methods of identifying regimes, and smoothing discontinuities between them, according to various embodiments of the invention.

FIG. 17 depicts an example wireline system, according to various embodiments of the invention.

FIG. 18 depicts an example drilling rig system, according to various embodiments of the invention.

### DETAILED DESCRIPTION

Thus, the existence of a multiphase flow can result in the existence of multiple regimes. Transitions between regimes become a major challenge for existing simulators and control systems when discontinuities arise. For example, some software tools attempt to implement a global approximation to remove discontinuities, which introduces global error and a loss of accuracy everywhere in the domain, even far from the discontinuities. Other systems retain the discontinuities at some level, to reduce global error over most of the domain, but fail to function appropriately or at all when the remaining discontinuities are encountered.

To address some of the challenges described above, as well as others, apparatus, systems, and methods are described herein that operate to smooth discontinuities in derived descriptive parameters, functions, data sets or empirical correlations, using a single consistent and universal approach while still minimizing global error. The proposed embodiments provide infinitely smooth transition zones while maintaining accuracy inside the regime domains that are not proximate to the transition zones. As a result, fluid flow simulators, and various operational control systems, can operate in a more predictable, accurate and reliable fashion.

For example, some embodiments include methods of flow regime identification, necessary for the smoothed calculation of pressure drops in pipe and wellbore flows. The smoothing procedures included in these methods in many cases also permit a machine to correctly determine which regime is present, and therefore, what action should be taken for proper operation.

For example, during the pump operation, the transition to a nearby undesirable regime (such as slug flow) can occur unexpectedly resulting in wild pressure and flow velocity oscillations, so that it may be necessary to shut down the pump, to allow transition back to the more favorable regime before restarting operations. With the knowledge of smooth weighting functions which indicate proximity to various regimes, a pump may be controlled to avoid transition to nearby undesirable regimes. In this case the power to the pump can instead be increased or decreased smoothly to avoid transition to the undesirable regime, without completely shutting the pump down and stopping operations.

To begin the discussion of various embodiments, it should be noted that for simulators and control systems that use first-order differencing schemes, the transition between regimes should be sufficiently smooth that all first derivatives of these descriptive parameters remain continuous and finite. That is to say, the scaled regime weighting functions should render the regime-weighted sum of descriptive parameters at least C¹ (having continuous first derivatives) throughout the independent parameter space Λₖ. If higher-order differencing schemes are used for improved accuracy, then the scaled regime weighting function should render a regime-weighted sum of descriptive parameter that has a sufficient number of continuous derivatives. Furthermore, the scaled regime weighting function for each regime should quickly approach a constant value within the regime, and decay quickly away from the boundaries of that regime. The regime weighting function will then be effectively restricted to influence only the region where it is meaningful, and the regime-weighted sum of descriptive parameters to a limited transition zone near the boundaries of that regime. For consistency and ease of understanding, some initial definitions will be provided.

### Definitions

Λₖ is the fundamental, independent parameter space.)

f_{m,n}(Λₖ) is a regime transition function, between regime m and regime(s) n.

f_{m,n}*(λₖ) is a normalized and restructured regime transition function, between regime m and regime(s) n.

f_{m,n}(Λₖ)=0 are the regime boundaries given by zeroes of the regime transition function between regimes m and n.

[symbol] is a smoothing function which operates on the normalized and restructured regime transition functions.

w_{m,n}(f_{m,n}*,ε) are intermediate smoothing functions between regime m and various n regimes.

ε is a small parameter that determines the steepness of the intermediate smoothing functions.

Wₘ(w_{m,n}) is a regime weighting function between regime m and all other regimes.

Wₘ* is a scaled regime weighting function between regime m and all other regimes.

p is a descriptive parameter/function of interest that may exhibit discontinuities between regimes.

### Smoothing Algorithm

Consider a set of regime boundaries described by equations f_{m,n}(Λₖ=0 for transitions from regime m to regime(s) n. In an equilibrium regime map, the boundary from regime m to n is also the boundary from regimen n to m and there is no constraint that imposes transitions in only one direction. The parameter space Λₖ on which the regime boundaries are defined include the fundamental, independent parameters, which are continuous either because they are physical quantities (e.g. density, temperature, etc.) or because they are only meaningful when they are, by definition, continuous (e.g. currency, energy, time, etc.). Since the parameters that make up the space Λₖ are continuous, then the space itself is continuous.

For the purposes of this discussion, it is useful to normalize the regime transition functions f_{m,n}(Λₖ) such that they have a magnitude of approximately one, and attain the limiting values of +1 and −1 (or slightly larger and smaller, respectively) somewhere in the domain. That is, they remain on the order of one or less everywhere throughout the domain, and are guaranteed to attain values of +1 and −1 somewhere in the domain.

These normalized regime transition functions are given by f_{m,n}*(Λₖ) where the asterisk denotes a function that is order one or less throughout the independent parameter space Λₖ. As a matter of standardization, the normalized regime transition functions are further structured such that f_{m,n}*(Λₖ)>0 when coincident with domain m, and f_{m,n}*(Λₖ)<0 when coincident with domain(s) n. This result can be obtained by multiplying f_{m,n}*(Λₖ) by the value −1 as needed. A regime transition function which has values both greater than and less than zero, over regions that occupy what is intended to be a single regime (e.g., for a regime function having multiple zero-levels), is not allowed, and suggests a physical violation of the space.

The intermediate smoothing functions W_{m,n} between regimes m and n are given by

$${W}_{m , n} ( {Λ}_{k} , ɛ ) = ( \frac{{f}_{m , n}^{*} ( {Λ}_{k} )}{ɛ} ) for all m < n \qquad ( 1 )$$

where ε is small parameter that determines the steepness of the smoothing functions and in general can be a function of f_{m,n}*(Λₖ).

[symbol] should be selected such that the resulting intermediate smoothing functions w_{m,n}(f_{m,n}*,ε) between regimes m and n have the following properties. They should vary between minimum and maximum limits that are fixed and known, such that they approach one limit when within the domain Ωₘ related to regime m, and such that they approach another limit outside the domain Ωₘ of regime m. Furthermore, they should have uniquely identifiable features (for example, inflection points) determined) by the zeros of f_{m,n}*(Λₖ). Examples will be presented later, to illustrate the selection of a specific [symbol] for a hypothetical regime map.

The remaining intermediate smoothing functions are given by

W_{n,m}=1−w_{m,n} for all m<n. (2)

The regime weighting function Wₘ for regime m is then given by the product

$${W}_{m} ( {Λ}_{k} , ɛ ) = {\prod }_{n \neq m} {w}_{m , n} \qquad ( 3 )$$

for all n regimes to which regime m can transition.

To simplify the numerical calculation of the product in equation (3)

it is acceptable to set w_{m,m}=1 throughout the parameter space. The regime weighting functions for any (m,n) not allowed (pairs between which transitions are not allowed) can also be set to a value of 1 throughout the parameter space, further simplifying the product calculation in equation (3), though in this case the prohibited pair (n, m) not allowed will not obey equation (2) and instead should also be set to 1.

Equation (2) results from the symmetry f_{m,n}*=−f_{n,m}*, which allows the alternative use of equation (1) for all combinations of m and n, not just m<n, except for the case m=n, without resorting to the use of equation (2).

Considering all lower-level dependencies, it is clear that the functional dependence of the regime weighting functions can be expressed by Wₘ=Wₘ(w_{m,n})=Wₘ(f_{m,n}*(Λₖ),ε). A regime-weighted descriptive parameter/function p at any location throughout the parameter space is then given by

$$p ( {Λ}_{k} , ɛ ) = \frac{1}{( {\sum }_{j} {W}_{j} )} {\sum }_{m} {W}_{m} {p}_{m} \qquad ( 4 )$$

where pₘ is a function describing a property of interest in the m^{th} regime.

In equation 4 the regime weighting functions are scaled by the sum of the value of all of the regime weighting functions, at that location in the parameter space Λₖ. To ensure the regime-weighted descriptive parameter/function is defined throughout the parameter space of interest, all terms on the right hand side of equation (4), including the regime weighting functions Wₘ, their sum, and the descriptive parameters/functions pₘ, are defined over the entire parameter space Λₖ. The scaled regime weighting functions Wₘ* are given by

$${W}_{m}^{*} ( {Λ}_{k} , ɛ ) = \frac{1}{( {\sum }_{j} {W}_{j} )} {W}_{m} \qquad ( 5 )$$

to guarantee that they sum to a value of 1 everywhere in the parameter space {Λₖ}. If the regime weighting functions are not scaled in this way, the values will sum to less than one within ε of the regime boundary transitions. This is true both for a regular boundary, where two regimes meet, and for locations in the regime map where multiple regimes meet, such as in the vicinity of triple points. Thus, the scaled regime weighting functions are formulated so as to sum to a value of one everywhere in the parameter space.

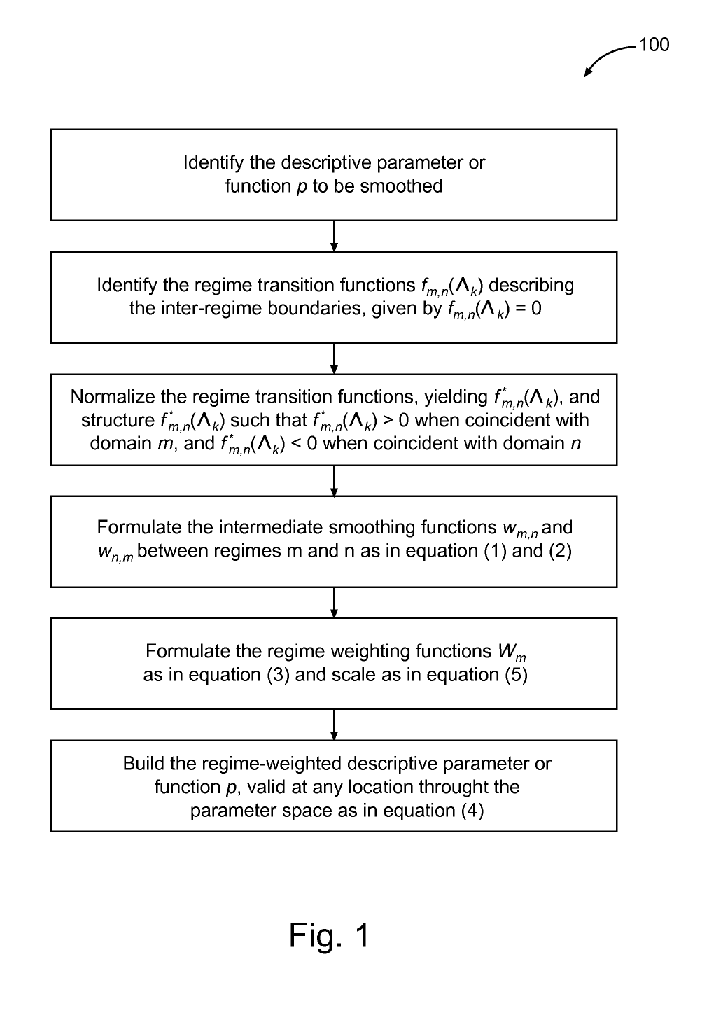

Equation (4) thus describes a function p(Λₖ) which is smooth everywhere in the space of parameters {Λₖ} and coincides with function pₘ(λₖ) inside the regime domain Ωₘ, away from the regime boundaries. This equation provides a mathematical foundation for various embodiments of the inventions that will be described herein. One method of application is outlined in FIG. 1, which is a flow diagram of regime-based discontinuity smoothing methods 100, according to various embodiments of the invention. An example implementation of these methods 100 will now be presented.

### Example 1: Hypothetical Regime Transitions

Consider a simple hypothetical system, which is described by two parameters Λₖ=x, y, has four regimes 1, 2, 3 and 4, with descriptive parameters p₁, p₂, p₃ and p₄, and regime boundaries defined by three regime transition functions:

f_{1,2}(x,y)=f_{2,3}(x,y)=−y+0.1(x−10)² (6)

f_{1,3}(x,y)=f_{3,4}(x,y)=−y+3 ln(x+6) (7)

f_{1,4}(x,y)=f_{2,4}(x,y)=−y+0.1x². (8)

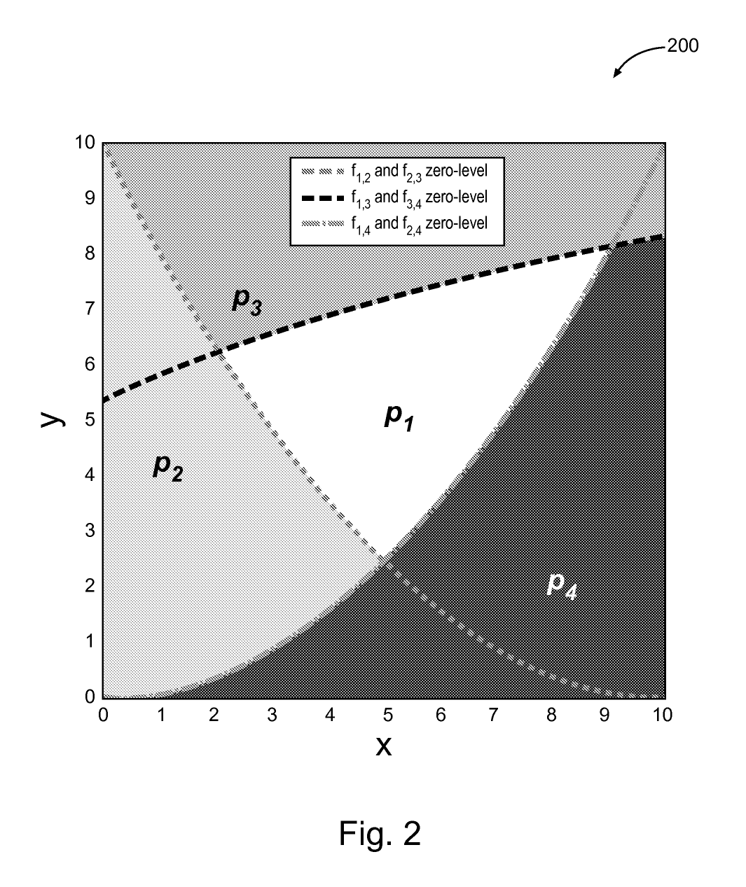

The zero-level curves of these regime transition functions are shown by the broken lines (i.e., dotted, dashed and dash-dot) in FIG. 2, which is a map 200 in two-dimensional, regime-based parameter space, of four regimes 1, 2, 3 and 4, with descriptive parameters p₁, p₂, p₃ and p₄, according to various embodiments of the invention. Here, the four regimes 1, 2, 3 and 4 (indicated by the filled regions) are designated in an x, y parameter space, with the various lines representing the zeroes of the three regime transition functions, and descriptive parameters p₁, p₂, p₃ and p₄ uniquely defined in each regime. The hypothetical regime transition functions selected for this example are smooth and bounded over the domain x=[0, 10] and y=[0, 10] in the parameter space Λₖ=x, y.

Here the local magnitude of each function plus 1 is selected as the norm. This choice is useful for most of the regime transition functions, and allows demonstrating a caveat of insufficient stretching for a few of the scaled regime transition functions. The addition of 1 removes any singularities in the normalization at x=y=0. Away from the transition boundaries given by the zero-level curves, the regime transition functions have positive and negative values.

In this case, restructuring indicates that the transition functions −f_{1,2}(x,y) and −f_{1,4} (x,y) be applied so that the associated surfaces are greater than zero when coincident with regime 1, and less than zero when coincident with then n^{th} regime of the (1,n) transition pair. An example of normalized and restructured regime transition functions for the transition combinations is given in equations (9)-(14), as

$$\begin{matrix}{f}_{1 , 2}^{*} ( x , y ) = - \frac{- y + 0.1 {( x - 10 )}^{2}}{\sqrt{1 + {y}^{2} + {[ 0.1 {( x - 10 )}^{2} ]}^{2}}} & ( 9 ) \\ {f}_{1 , 3}^{*} ( x , y ) = \frac{- y + 3 ln ( x + 6 )}{\sqrt{1 + {y}^{2} + {[ 3 ln ( x + 6 ) ]}^{2}}} & ( 10 ) \\ {f}_{1 , 4}^{*} ( x , y ) = - \frac{- y + 0.1 {x}^{2}}{\sqrt{1 + {y}^{2} + {[ 0.1 {x}^{2} ]}^{2}}} & ( 11 ) \\ {f}_{2 , 3}^{*} ( x , y ) = - {f}_{1 , 2}^{*} ( x , y ) = \frac{- y + 0.1 {( x - 10 )}^{2}}{\sqrt{1 + {y}^{2} + {[ 0.1 {( x - 10 )}^{2} ]}^{2}}} & ( 12 ) \\ {f}_{2 , 4}^{*} ( x , y ) = {f}_{1 , 4}^{*} ( x , y ) = - \frac{- y + 0.1 {x}^{2}}{\sqrt{1 + {y}^{2} + {[ 0.1 {x}^{2} ]}^{2}}} & ( 13 ) \\ {f}_{3 , 4}^{*} ( x , y ) = - {f}_{1 , 3}^{*} ( x , y ) = - \frac{- y + 3 ln ( x + 6 )}{\sqrt{1 + {y}^{2} + {[ 3 ln ( x + 6 ) ]}^{2}}} & ( 14 )\end{matrix}$$

such that f_{m,n}*(x,y)>0 when coincident with domain m, and f_{m,n}*(x,y)<0 when coincident with domain n.

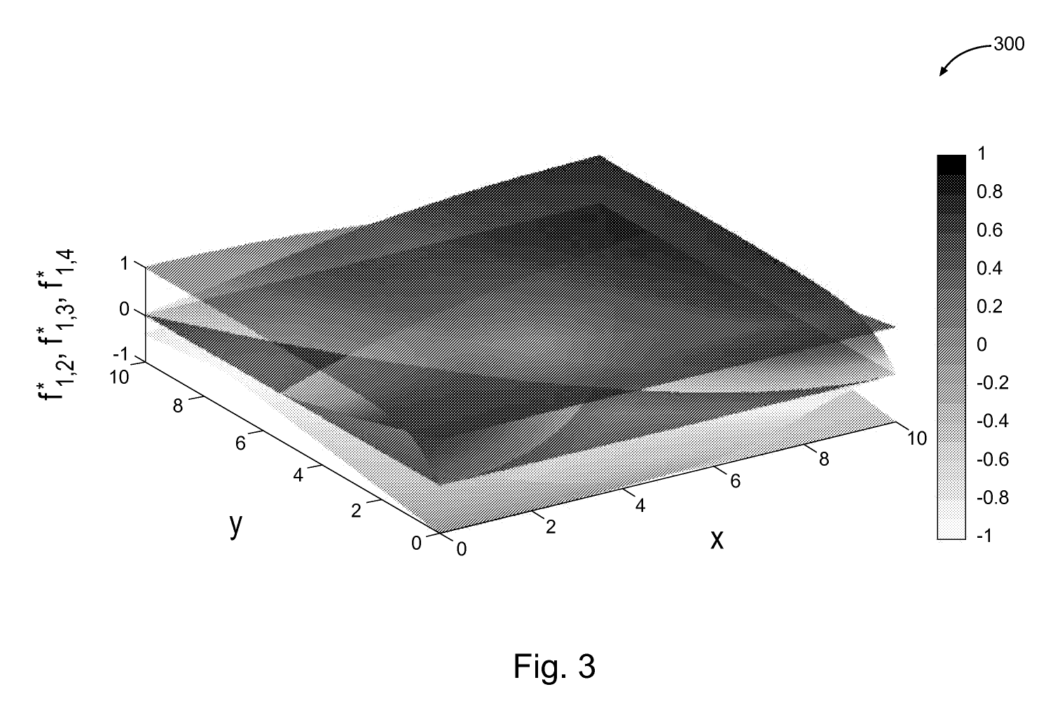

The surface plots of the regime transition functions for all regimes, after normalization and restructuring, are shown in FIG. 3, which is a three-dimensional map 300 of normalized and restructured regime transition functions, according to various embodiments of the invention. Here, surfaces of the three normalized and restructured regime transition functions, and the zero surface, are shown. The normalization choice has the effect f_{1,2}*, f_{2,3}*, f_{1,4}* and f_{2,4}* over a range of −0.995 to +0.995 throughout the domain. Technically these values should be divided by 0.995 to ensure that they range from −1 to +1, but it will be shown that even a moderately small choice of ε will be sufficient to gain high accuracy for the [symbol] selected. However, f_{1,3}* varies only from −0.4058 to +0.993 and f_{3,4}* thus varies from −0.993 to +0.4058, which demonstrates insufficient stretching. This can be seen for f_{1,3}* in FIG. 3 at x=0 and y=10. It is a better practice to stretch both of these further by dividing by 0.4058 such that they span the range of −1 to +1. However, because the regime transition functions used in this example are very smooth, it is sufficient to instead use a very small value of ε. In some embodiments, this arrangement will not be sufficient, and the practice of stretching the regime transition functions to at least +1 and −1 somewhere in the domain should be used.

Further consider that the descriptive parameter of interest p is described by four different functions, pₘ, for m=1, 2, 3 and 4, one in each regime, as indicated in FIG. 2. In general the functions describing pₘ may exhibit discontinuities at the regime boundaries. The smoothing algorithm provides a smoothed representation of p over the entire parameter space. For example, suppose these descriptive parameters pₘ are defined within their respective regimes by

$$\begin{matrix}{p}_{1} ( x , y ) = α \frac{{( y + x )}^{2}}{d} & ( 15 ) \\ {p}_{2} ( x , y ) = ( 0.1 α - 0.9 β ) \frac{{( y + x )}^{2}}{d} & ( 16 ) \\ {p}_{3} ( x , y ) = ( 0.2 α + 0.7 β ) \frac{{( y + x )}^{2}}{d} & ( 17 ) \\ {p}_{4} ( x , y ) = ( 0.7 α + 0.3 β ) \frac{{( y + x )}^{2}}{d} & ( 18 )\end{matrix}$$

with arbitrary constants set to α=1000, β=1.2, and d=0.06.

These functions do not smoothly transition from one to another on the boundaries. The novel smoothing algorithm described herein and illustrated by the method 100 in FIG. 1 provides a smooth representation of p over the entire parameter space {Λₖ}={x,y} and minimizes the error far from the regime transition boundaries.

In this example, the smoothing function [symbol] which operates on the regime boundary transition functions is selected to be the hyperbolic tangent function. Then, the intermediate smoothing functions W_{m,n} between regimes m and n are given by

$${w}_{m , n} ( x , y ) = \frac{1}{2} [ 1 + tanh ( \frac{{f}_{m , n}^{*} ( x , y )}{ɛ} ) ] \qquad ( 19 )$$

In this example, ε can be taken as a fixed value relative to Δx and Δy, which are the discretization step sizes in x and y, respectively, which are taken to be the same and uniform. The intermediate smoothing functions w_{m,n}(f_{m,n}*,ε) given by equation (19) will then vary between zero and one, having values that are greater than 0.5 within the portion of the space where they identify regime m, with inflection points determined by the zeros of f_{m,n}*(x,y).

In general, ε should be selected such that it provides sufficient, but not excessive, smoothing of the functions w_{m,n}(f_{m,n}*,ε). For the chosen hyperbolic tangent smoothing function in this case, it is desirable to span roughly five discretization steps from the 0.01 to 0.99 values of each W_{m,n} at a regime boundary. As the resolution of the numerical representation increases (here indicated by decreasing Δx and Δy), the value of ε can be decreased to maintain the same smoothing influence over the same number of discretization points, if desired. Because the normalization used did not permit the normalized and restructured regime transition functions to attain values of +1 and −1, it is useful to use a relatively small ε to ensure that the intermediate smoothing functions will all approach zero and one.

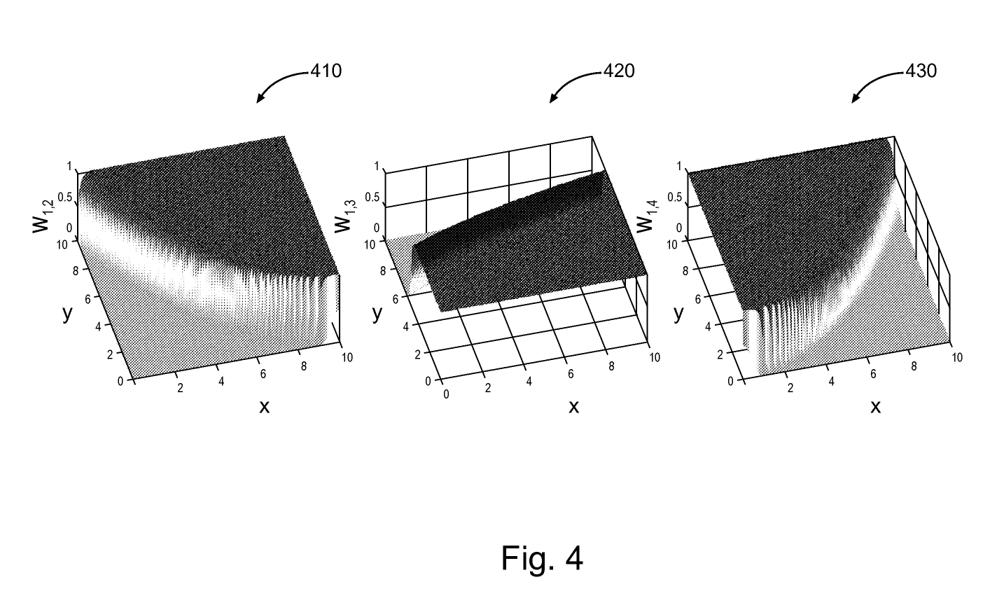

Three intermediate regime smoothing functions 410, 420, 430 (i.e., w_{1,2}, w_{1,3}, and w_{1,4}) between regimes 1 and 2, 1 and 3, and 1 and 4, respectively, are shown in FIG. 4, which illustrates these functions for regime 1 of FIG. 2, according to various embodiments of the invention. These surfaces are shown for values of Δx=Δy=0.1 and ε=0.0333. Similar surfaces exist for the smoothing functions from regimes 2, 3 and 4.

The product of the three intermediate smoothing functions 410, 420, 430 shown in FIG. 4 gives the regime weighting function for regime 1 via

$${W}_{1} = {\prod }_{n \neq 1} {w}_{1 , n} \qquad ( 20 )$$

for all n regimes to which regime 1 can transition.

Similar regime weighting functions are evaluated following the same procedure for regimes 2, 3 and 4. The results are omitted here for brevity. The regime weighting functions are then scaled locally (in {Λₖ}={x,y}) to produce the scaled regime weighting functions Wₘ* . For example, in regime 1 this is given by

$${W}_{1}^{*} = \frac{1}{( {\sum }_{j} {W}_{j} )} {W}_{1} . \qquad ( 21 )$$

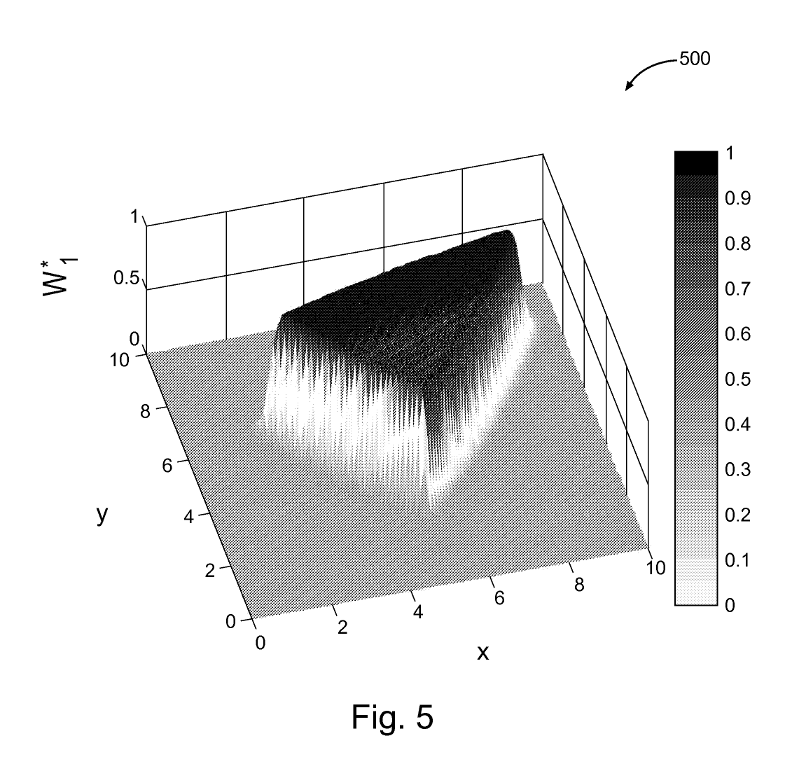

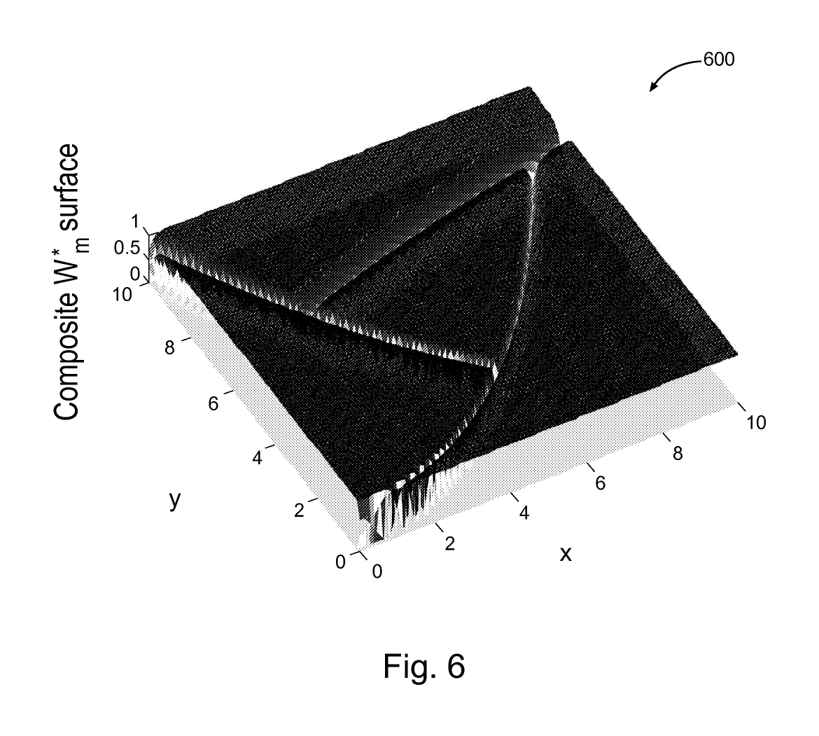

This scaled regime weighting function W₁* is shown in FIG. 5, which illustrates a scaled regime weighting function 500 for regime 1 of FIG. 2, according to various embodiments of the invention. A representation of all of the scaled regime weighting functions is shown in FIG. 6, which is a composite surface plot 600 of all scaled regime weighting functions, according to various embodiments of the invention. If added, these surfaces sum to a value of 1 at every x, y location, according to the scaling set forth by equation (5).

Notice that the smoothing produces a wider gap for larger values of x and y. This is due to the local nature of the normalization used in equations (9)-(14). This produces the desired effect, such that the smoothing is proportional to the magnitude of the fundamental, independent parameters. Alternatively, if x and y were both normalized to vary between values of 0 and 1, then the gap would be consistent within that normalized space, as desired.

The smoothed, regime-weighted descriptive parameter/function p at any location throughout the parameter space is then given by

$$p ( x , y ) = \frac{1}{( {\sum }_{j} {W}_{j} )} {\sum }_{m} {W}_{m} {p}_{m} ( x , y ) \qquad ( 22 )$$

for all m regimes where the regime weighting functions Wₘ are scaled to sum to a value of 1 everywhere in the parameter space. Alternatively, the scaled regime weighting functions Wₘ* can be used directly as seen from a comparison of equations (22) and (21).

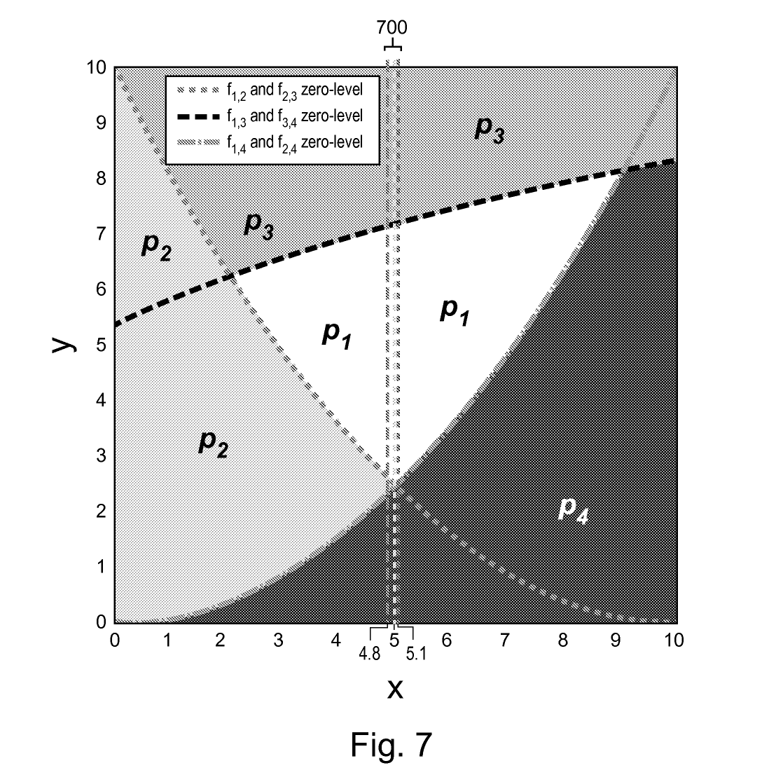

Three slices 700 of the regime-based parameter space shown in FIG. 2 have been taken at values of x=(4.8, 5.0, and 5.1) near and through the triple point at x=5.0 in FIG. 7. By plotting the regime-weighted descriptive parameter/function p along these slices, it is possible to show the effect of the smoothing. The discretization used in this example is again Δx=Δy=0.1, with ε=0.0333.

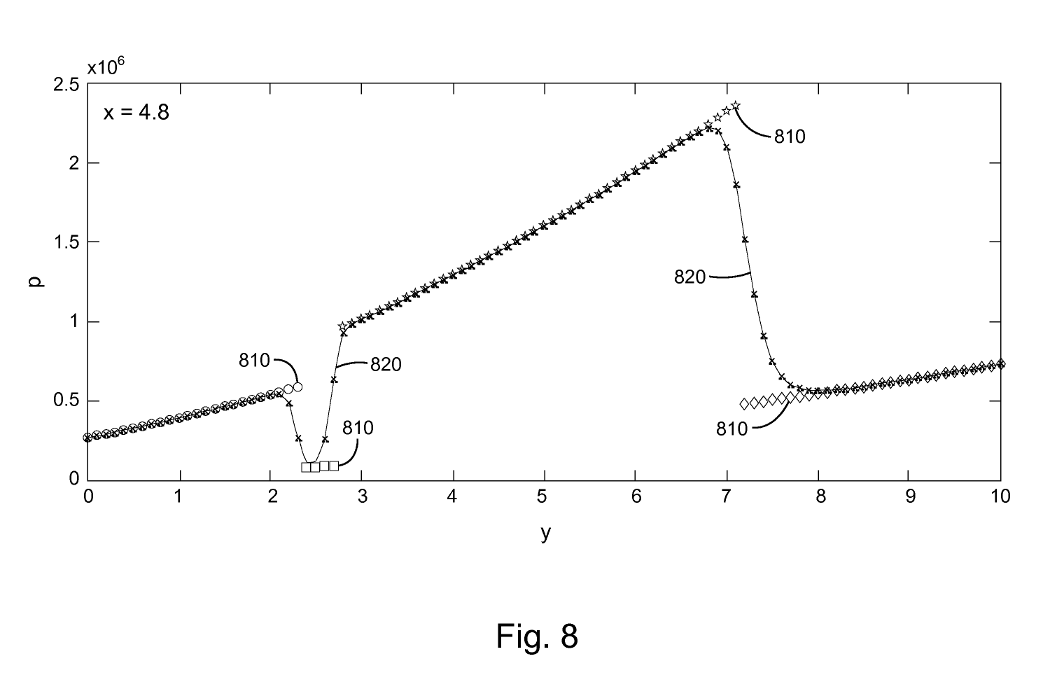

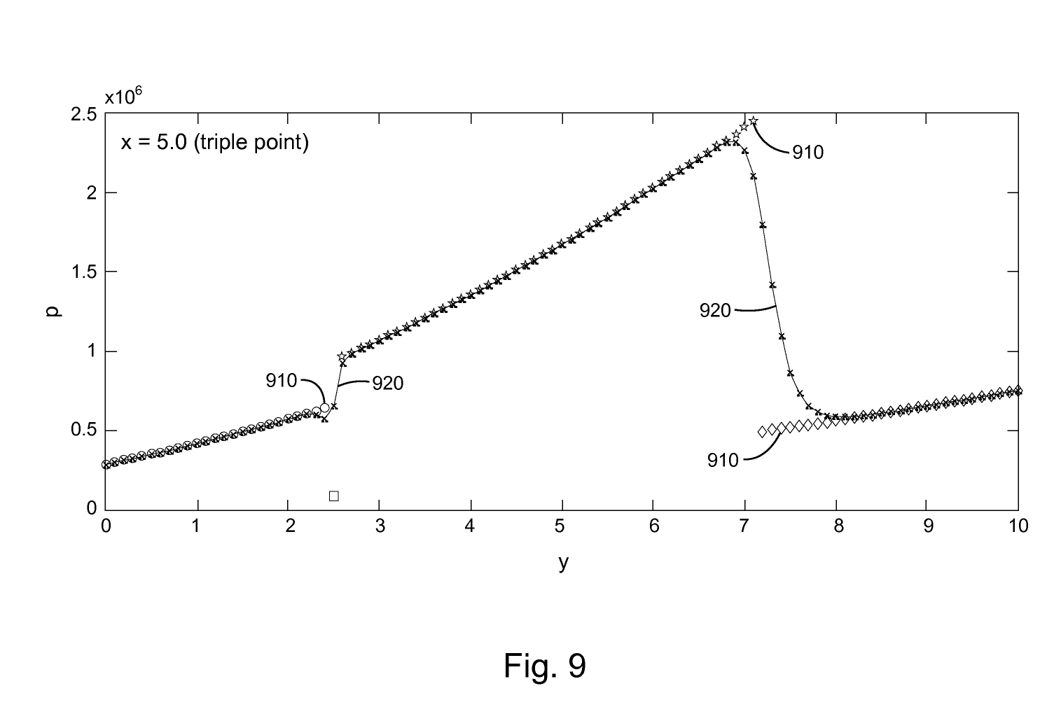

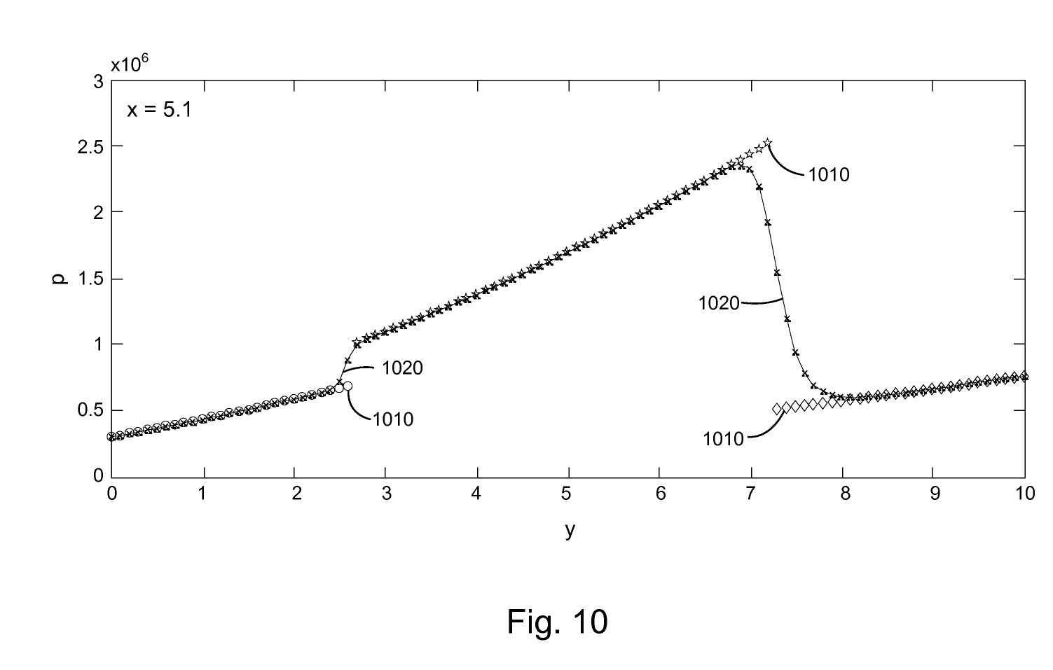

FIGS. 8-10 illustrate the original and smoothed descriptive parameter/function values 810, 820; 910, 920; 1010, 1020 for each slice taken in FIG. 7, respectively, according to various embodiments of the invention. The open symbols in FIGS. 8-10 represent the values 810, 910, 1010 of the original discontinuous descriptive parameters pₘ for regions intersected by the three slices, moving in order of increasing values of y. That is, FIG. 8 shows the four original parameter pₘ values 810, and the regime-weighted, smoothed descriptive parameter/function p values 820 at x=4.8. FIG. 9 shows the four original parameter pₘ values 910, and the regime-weighted, smoothed descriptive parameter/function p values 920 at x=5.0 (i.e., at the triple point). Similarly, FIG. 10 shows the three original parameter pₘ values 1010, and the regime-weighted, smoothed descriptive parameter/function p values 1020 at x=5.1 (regime 2 is excluded from this slice).

The continuous lines 820, 920, 1020 thus indicate values of the smoothed, regime-weighted descriptive parameter p, as given by equation (22). Note that the values 820, 920, 1020 of this function are smooth even in the regions of high gradients. Any apparent discontinuity in the plots of the parameter p are due to plotting resolution, and not to the mathematical result. This completes the first example, and to increase understanding, another will now be presented.

### Example 2: Physical Scenarios

In this example, some physical scenarios that implement the novel smoothing methods described herein are set forth. One case to consider involves fluid flow transitions, perhaps occurring as part of a petroleum recovery operation. These can include the transition from laminar to turbulent flow in any fluid, or the transition to a new flow regime (e.g., dispersed bubble to slug flow) in a multiphase flow. The associated pressure drop and convective heat transfer coefficients are typically discontinuous across these flow regime transitions. Sub-examples of transition from laminar to turbulent flow for a single-phase fluid, and transition from one regime to another for a two-phase, gas-liquid flow are given below.

### Example 2.1: Laminar to Turbulent Transition in Single-Phase Flow

Discontinuities that appear in physical systems include the pressure drop and heat transfer across the transition from laminar to turbulent single-phase flow. A single fundamental, independent parameter, the Reynolds number R, can be used to describe this regime transition.

The Reynolds number is a ratio of inertial to viscous effects. Associated descriptive parameters include the friction factor and related pressure drop, and the Nusselt number, N. For low values of the Reynolds number, the flow will be laminar. As the value of the Reynolds number increases, at some point the flow will transition to turbulence. For example, laminar pipe flow is usually stable until approximately reaching a Reynolds number, value of R=2000, based on the pipe diameter. Above a Reynolds number value of roughly R=4000, the flow becomes fully turbulent.

Models of the friction factors and pressure drops for both laminar and turbulent pipe flows have been developed. However, these exhibit a strong discontinuity in the transition region, where the Reynolds number ranges from 2000<R<4000. In this region, neither limiting model is fully valid. However, various embodiments of the smoothing methods presented herein can be used to smooth transitions over the friction factor and pressure drop models from one regime to the other.

Similarly, the Nusselt number is a ratio of convective heat transfer to thermal conduction. For laminar pipe flow with either a uniform heat flux or constant surface temperature, the Nusselt number N can be given by one of two constant values. However, if the flow transitions to turbulence, the value of the Nusselt number N becomes a function of both the Reynolds number R and a second fundamental, independent parameter, the Prandtl number P. Again, the novel smoothing methods described herein can remove the discontinuity that may be present in the change between Nusselt numbers (which are the descriptive parameters) across regimes.

### Example 2.2: Regime Transition in Two-Phase, Gas-Liquid Flow

A more complicated example from fluid mechanics is multiphase flow in channels and pipes. Two- and three-phase flows present many different flow regimes as the fluid parameters are changed. Regime maps based on fundamental, independent parameters have been developed by several authors, which attempt to provide a unified model for two-phase, gas-liquid flow in pipes at any inclination angle. For many of these regimes, mechanistic and empirical models of pressure drop and heat transfer have been formulated. However, the pressure drop correlations developed for different regimes do not smoothly match at the inter-regime boundaries. The same difficulty exists with respect to heat transfer correlations. Since the existence of discontinuities can disrupt the operation of multiphase simulators and control systems, the smoothed calculation of pressure drop and heat transfer can be very useful in a variety of industrial activities.

Even for a two-phase, gas-liquid flow, the space of fundamental, independent parameters Λₖ is large. It includes the densities (ρ_{L}, ρ_{G}), viscosities (μ_{L}, μ_{G}), and superficial velocities (v_{SL}, v_{SG}) of the liquid and gas, as well as the surface tension for the liquid in contact with the gas σ_{L}, and the pipe diameter d and inclination angle θ, measured from horizontal and varying between −90° (for vertical downward flow) to +90° (for vertical upward flow). The final independent parameter that should be considered is the pipe roughness, r.

A collection of regime transition functions determines in which of eight two-phase regimes the flow exists. These include the regimes of: dispersed bubble, bubbly, stratified smooth, stratified wavy, annular, slug, churn, and elongated bubble. Various closure relations, such as those dealing with friction between the phases, are used to predict the pressure drop in each regime. The simplifications tied to these closure relations result in discontinuities in the predicted pressure drop at regime boundaries. Similarly, heat transfer, which can be quantified by specific N relations, may exhibit discontinuities at regime boundaries. Additionally, when the mass flow rate of either fluid component becomes negligible compared to the other, the regime may be modeled as a single-phase regime. Or, when the flow of both components slows to nearly zero velocity, the regime may be modeled as a quiescent mixture.

These three additional regimes, single-phase liquid, single-phase gas, and quiescent mixture may also exhibit discontinuities when transitioning to the eight above mentioned two-phase flow regimes. Using the novel smoothing methods discussed herein, smoothed pressure drop and heat transfer correlations can be used to remove the discontinuities at all of the above mentioned regime boundaries and stabilize the performance of simulation and control operations.

To summarize to this point, in various embodiments, the methods illustrated by FIGS. 1-10 can be applied independently of how the regimes are defined, because the smoothing is based on fundamental, independent parameters. These fundamental, independent parameters are continuous because they are either physical (e.g. density, temperature, etc.) or only meaningful when continuous by definition (e.g. time, etc.).

As a matter of contrast, the performance of conventional smoothing procedures is determined by the behavior of the numerical solution on the mesh discretizing the physical space, or on artificial physical constraints, and thus, is subject to unpredictable failures.

Moreover, the various embodiments of methods described herein are consistent and universally applicable throughout the fundamental, independent parameter space. Regime transition mechanisms can be modified, added or removed, with no impact on the method. In contrast, existing smoothing procedures are ad hoc, and therefore must be specifically corrected when any regime transition mechanisms are modified, added or removed.

In addition, the various embodiments of the methods disclosed herein can even provide measures of the proximity of neighboring regimes, the respective weighting of those regimes, and indications of the probabilities that those regimes will exist. For example, the relative proximity of neighboring regimes is known directly from the value of the scaled regime weighting functions, Wₘ*. As the m^{th} regime is approached, the scaled regime weighting function Wₘ* will increase from 0. When the value wₘ* is 0.5, the parameters are such that the m^{th} regime is equally likely to be selected as compared to the neighboring regime for describing the system state (or if there is more than one neighbor, every neighboring regime will be equally likely when the values of their scaled regime weighting functions are all 1/(the number of regimes), for example 1/3 at a triple point). Once the parameters place the system state within the m^{th} regime, the value of Wₘ* will be greater than 0.5, but not more than 1. When Wₘ* approaches 1, the system state can only exist in the m^{th} regime. For regimes defined by equilibrium conditions, the values of the Wₘ* for all m regimes serve as a measure of the probability of the regime in which the system will exist. These measures of proximity and probability are not found in ad hoc and other specialized smoothing procedures.

Finally, after the scaled regime weighting functions Wₘ* are evaluated, they can be applied to smooth any and all subsequent derived parameters (i.e., those other than the fundamental, independent parameters Λₖ), data, and correlations that describe additional features of interest within the regime. This is not the case for existing smoothing procedures, where ad hoc arguments must be considered for each additional feature where smoothing is desired. These advantages can be quite significant when applied to the physical world.

### Applications for Simulation and Control Systems in Two-Phase, Gas-Liquid Flows

Prior to delving into the particulars of a more detailed example, some preliminary information will be provided. To begin, it should be noted that two-phase, gas-liquid flows can exist in several different flow regimes, often characterized by a geometric flow pattern. A set of independent parameters determines which regime is preferred, through the use of various mechanistic arguments. In various embodiments, a mechanism is provided for finding the regime via a universal approach illustrated by FIGS. 1-10, which is computationally efficient and flexible enough to accommodate the addition of new mechanistic arguments. This mechanism can be applied to smooth flow functions of interest, including pressure drop and heat transfer coefficients.

According to the literature, two-phase, gas-liquid flow in pipes can exist in eight regimes (noted previously), which in turn depend on the independent parameters shown in Table I, forming an independent parameter space {Λₖ}.

TABLE I

| Symbol | Description |
|---|---|
| ρ_{L} | liquid density |
| ρ_{G} | gas density |
| μ_{L} | liquid viscosity |
| μ_{G} | gas viscosity |
| V_{SL} | superficial liquid velocity |
| V_{SG} | superficial gas velocity |
| σ_{L} | surface tension of the liquid in |
| | contact with the gas |
| D | pipe diameter |
| θ | pipe inclination angle, measured |
| | from horizontal |
| r | pipe-wall roughness |

The eight flow regimes that might be expected to exist in the flow of a two-phase, gas-liquid pipe are identified in Table II, and the single-phase and quiescent mixture are also included.

TABLE II

| | | Collective |
|---|---|---|
| Number | Regime | Designation |
| 1 | dispersed bubble | n/a |
| 2 | stratified smooth | stratified |
| 3 | stratified wavy | |
| 4 | annular | n/a |
| 5 | slug | intermittent |
| 6 | churn | |
| 7 | elongated bubble | |
| 8 | bubble (also referred to | n/a |
| | as bubbly) | |
| 9 | single-phase gas | n/a |
| 10 | single-phase liquid | n/a |
| 11 | quiescent mixture | n/a |

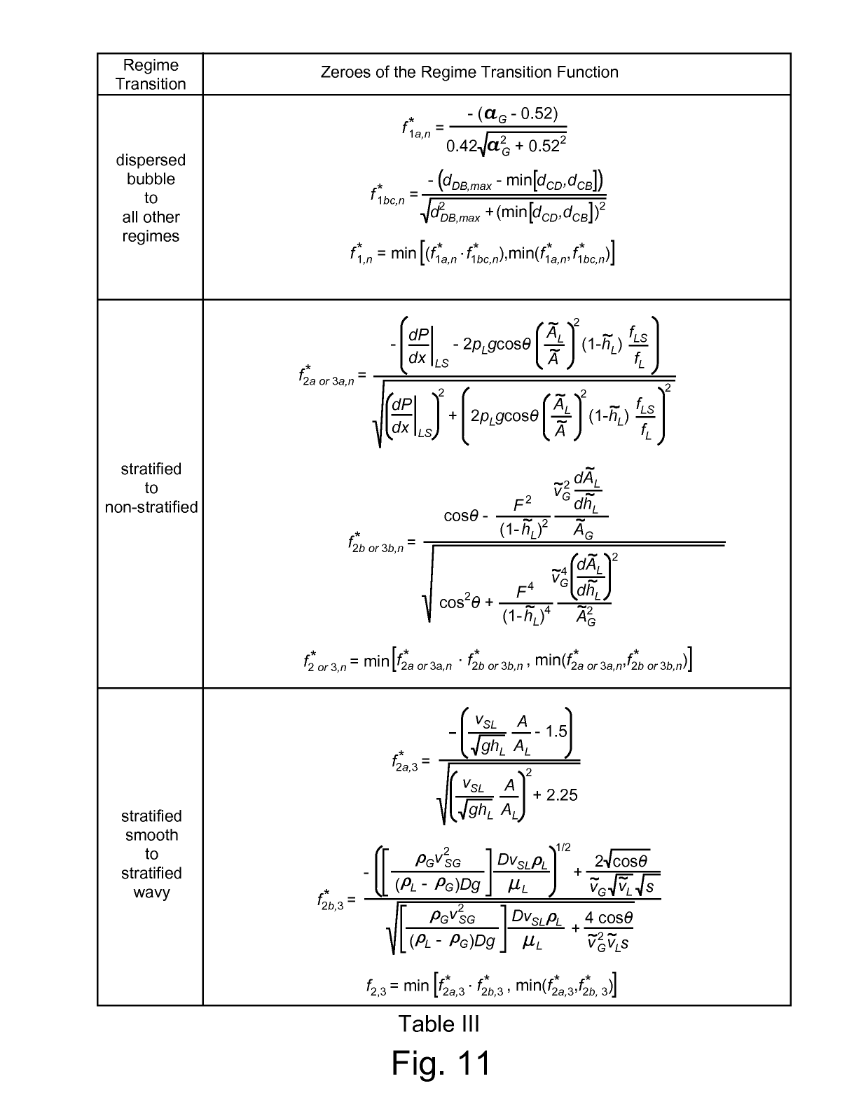

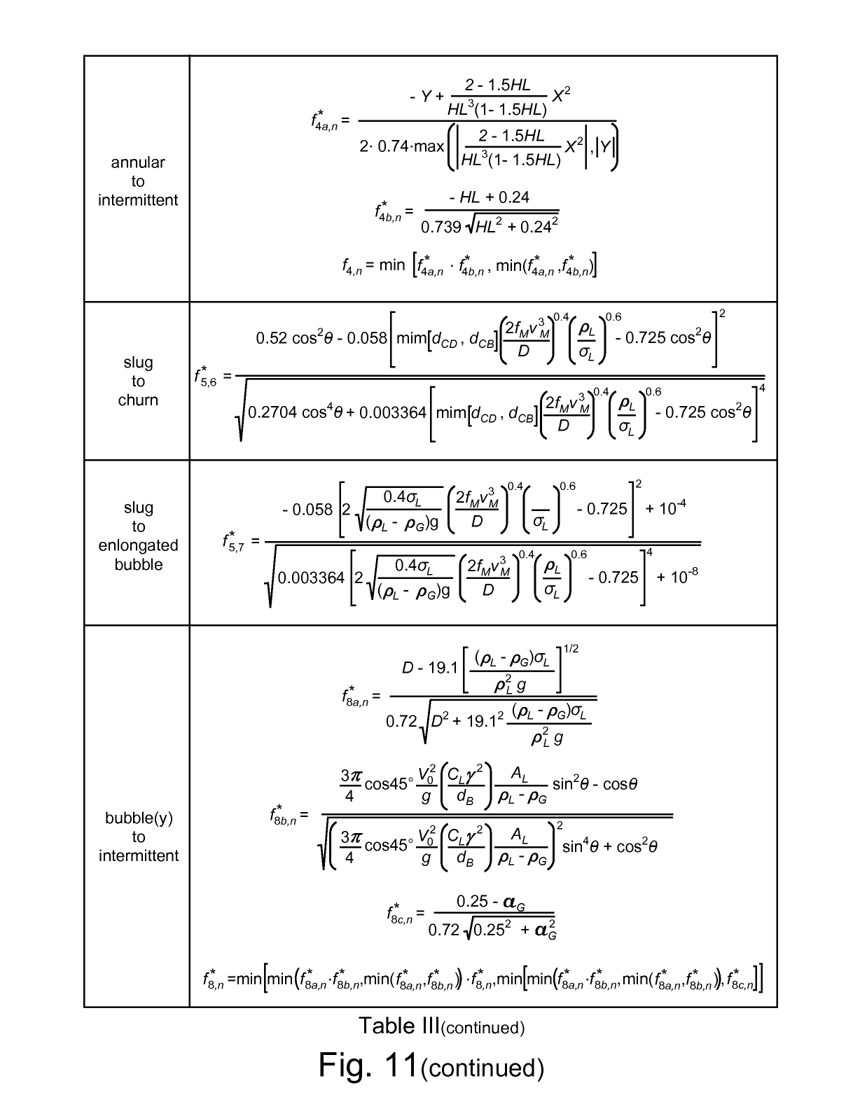

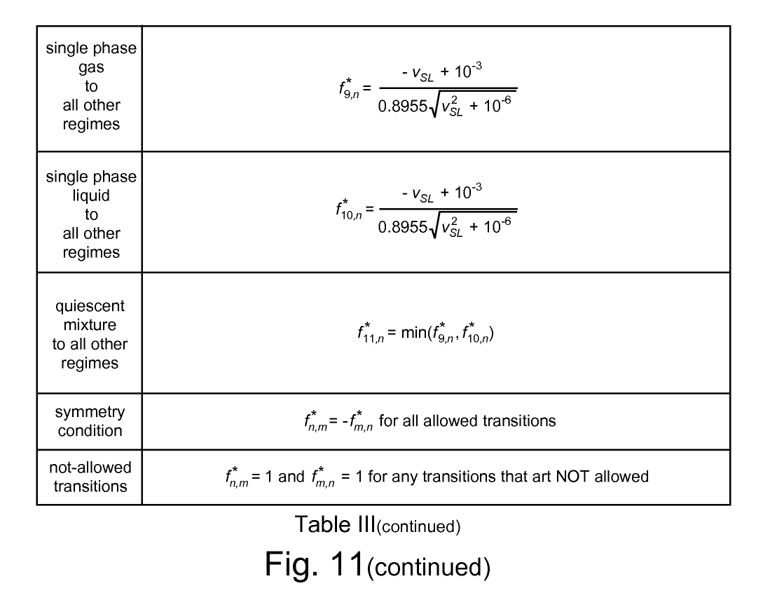

In general, a regime may transition to many (or all) other regimes, depending on how the independent parameters vary. However, there are at least two ways that a regime may be identified. For example, a particular regime transition function may be of type (1) necessary, but not sufficient to uniquely identify a regime, or of type (2) necessary and sufficient to uniquely identify a regime. Furthermore, the existence of a regime may be described by multiple regime transition functions, which may occur in any combination of these two scenarios. The mechanistic regime transition functions between each of the regimes are well known to those of ordinary skill in the art, and are summarized for convenience in Table III (shown as part of FIG. 11. and not included in this text, for reasons of legibility). In the form shown, multiple known regime transition functions have been combined via logic arguments (minimization and/or maximization).

An alternative description of these regime transition functions is that of surfaces in the independent parameter space {Λₖ}, the existence of which determines whether a particular regime exists or does not exist for any given space Λₖ. While the individual sub-functions are based on physical arguments which may transition to a specific regime or regimes, the regime transition functions in Table III that are composites of multiple sub-functions may no longer indicate to which specific regime a transition occurs. That is, once formulated via logic arguments according to Table III, each regime transition function indicates only whether the regime exists, or not.

The regime transition functions of Table III include many derived parameters, which depend on {Λₖ}, and a variety of empirical constants, which are shown in Table IV. The meaning and significance of these parameters are well known to those of ordinary skill in the art, who will also be familiar with the selection of values for various constants and fitting parameters, as found in numerous references.

TABLE IV

| Symbol | Description |
|---|---|
| α_{G} | volume fraction of gas |
| d_{DB,max} | maximum diameter of dispersed (bubble) phase that is stable |
| | (breakup resistant) for a given level of turbulence |
| d_{CD} | maximum diameter at which dispersed bubbles will remain |
| | undeformed and thus coalescence resistant based on a |
| | balance of surface tension and buoyancy |
| d_{CB} | maximum diameter where bubbles will be remixed into the |
| | liquid matrix rather than buoyantly convected to the top inside |
| | wall of the pipe |
| F | Froude number modified by the density ratio of the liquid and |
| | gas |
| \tilde{h}_{L} | liquid height (level) in equilibrium stratified flow, normalized |
| | by the pipe diameter D |
| Ã_{L} | liquid cross-sectional area, normalized by D² |
| Ã_{G} | gas cross-sectional area, normalized by D² |
| \tilde{V}_{G} | gas velocity, normalized by the superficial gas velocity |
| h_{L} | liquid height (level) in equilibrium stratified flow |
| \tilde{V}_{L} | liquid velocity, normalized by the superficial liquid velocity |
| s | sheltering coefficient |
| HL | liquid hold up |
| X | Lockhart and Martinelli parameter |
| Y | dimensionless gravity group |
| f_{M} | friction factor based on the mixture velocity |
| V_{M} | mixture velocity |
| C_{L} | coefficient of lift on a bubblybubble (values of 0.4-1.2) |
| γ | distortion coefficient of a bubbly bubble (values of 1.1-1.5) |

To further describe some variations of the methods disclosed herein, it is useful to set forth additional symbolic nomenclature definitions, per Table V. It should be noted that this is a specialized case of the more general procedures described above. Here, the ability of some embodiments to provide smoothly varying results, as well as to identify the existence of regimes, is demonstrated.

TABLE V

| Symbol | Description |
|---|---|
| Λₖ | fundamental, independent parameter space given in Table I |
| f_{m,n}(Λₖ) | regime transition function, between regime m and |
| | regime(s) n |
| f*_{m,n}(Λₖ) | normalized and restructured regime transition function, |
| | between regime m and regime(s) n |
| W_{m,n}(f_{m,n}, ε) | intermediate smoothing functions between regime m and |
| | various n regimes |
| ε | small parameter that determines the steepness of the |
| | intermediate smoothing functions |
| Wₘ(W_{m,n}) | regime weighting function between regime m and all other |
| | regimes |
| W*ₘ(W_{m,n}) | scaled regime weighting function between regime m and |
| | all other regimes |

Consider a two-phase flow regime m, determined by the mechanistic arguments in Table III that form a set of regime transition functions f_{m,n}(Λₖ) for transitions from regime m to regime(s) n, and depend on the set of independent parameters Λₖ in Table I. The zero-levels f_{m,n}(Λₖ)=0 then define the boundaries of regime m. The regime transition functions f_{m,n}(Λₖ) are normalized locally such that they retain values of order one throughout the domain. This should be carried out term-wise for regime transition functions with multiple sub-conditions that lead to a product of intermediate smoothing functions.

The normalized regime functions are given by f_{m,n}*(Λₖ), where the asterisk denotes a function that is order one throughout the parameter space Λₖ. The normalized regime transition functions are further structured such that f_{m,n}* (Λₖ)>0 when coincident with the domain of regime m, and f_{m,n}* (Λk)<0 when coincident with the domain(s) of regime(s) n, f_{m,n}*(Λₖ) by multiplying by a value of −1 when needed.

As an example of normalization, restructuring, stretching and combining functions, consider the regime transition function from the dispersed bubble regime to all other regimes. For dispersed bubble flow to exist, three regime transition functions should be satisfied, corresponding to the physical conditions α_{G}<0.52 and d_{DB,max}<d_{CD} and d_{DB,max}<d_{CB} well known to those of ordinary skill in the art. When in the combined form the existence of the combined surface only indicates if the dispersed bubble regime exists or does not exist—it no longer directly provides information about the regime to which the transition occurs. The first regime transition function becomes f_{1a,n}=−(α_{G}−0.52), where the minus sign gives the function the proper structure such that it is positive when coincident with the dispersed bubble regime. Then it is scaled by \sqrt{α_{G}²+0.52²}. However, since it is well known to those of ordinary skill in the art that α_{G}, which is a gas volume fraction, can only vary between 0 and 1, the suggested scaling will not ensure that the regime transition function will span the range of −1 to 1. To ensure this, it is useful to further scale or stretch by the minimum magnitude of the extreme value, which is 0.42 for this function. Thus, the properly structured, scaled, and stretched regime transition function becomes f_{1a,n}*=−(α_{G}−0.52)/(0.42\sqrt{α_{G}²+0.52²}).

It is possible to combine the remaining two functions via a minimum into a new combined function f_{1bc,n}=d_{DB,max}−min[d_{DC},d_{CB}]. This is restructured and normalized via f_{1bc,n}=−f_{1bc,n}/\sqrt{d_{DB,max}²+(min[d_{CD},d_{CB}])²} such than it is positive when coincident with the dispersed bubble regime. Over the two-phase parameter space well known to those of ordinary skill in the art, f_{1bc,n}* varies between +1 and −1 and thus needs no additional scaling.

The functions f_{1a,n}* and f_{1bc,n}* can then be combined via minima arguments to produce

f_{1,n}*=min[(f_{1a,n}·f_{1bc,n}*),min[f_{1a,n}*,f_{1bc,n}*]] (23)

In equation (23), f_{1,n}* will now be positive when coincident with regime 1 in the parameter space. Using min/max arguments in this way, even when the units of the arguments are not consistent, is acceptable because only comparison with a value of zero is important.

Once all regime transition functions in Table III have been normalized, stretched and restructured, the intermediate smoothing function(s) for each regime m, in its transition to various n regimes, are given by

$${w}_{m , n} ( {Λ}_{k} , ɛ ) = \frac{1}{2} [ 1 + tanh ( \frac{{f}_{m , n}^{*} ( {Λ}_{k} )}{ɛ} ) ] . \qquad ( 24 )$$

The values of these intermediate smoothing functions vary between zero and one, are greater than 0.5 within the portion of the parameter space where they identify regime m, are less than 0.5 outside of parameter space where they identify regime m, and have inflection points determined by the zeros of f_{m,n}*(Λₖ).

Note that the relation w_{n,m}=−1−w_{m,n} presented in the general smoothing method 100 (refer to FIG. 1), while convenient for calculations, should be used with some care when not all transitions are allowed. Only when a transition to every other regime is possible, such that no regime transition functions are set to 1 (as occurs in Table III), will the relationship w_{n,m}=1−w_{m,n} hold rigorously. Alternatively, the intermediate smoothing functions can be built individually for each regime using equation (24), with each transition function f_{m,n}*(Λₖ) considered for all combinations of m≠n, rather than only considering m>n. With care, either method is acceptable.

The regime weighting function Wₘ for each regime m is then given by the product

$${W}_{m} ( {Λ}_{k} , ɛ ) = {\prod }_{n \neq m} {w}_{m , n} \qquad ( 25 )$$

for all combinations of m and n. Indeed, in this instance it is permitted that m=n, since f_{m,n}=1 was set in Table III.

The regime weighting functions should be scaled by the sum of the value of all of the regime weighting functions, at each location in the parameter space Λₖ. The scaled regime weighting functions Wₘ* are given by

$${W}_{m}^{*} ( {Λ}_{k} , ɛ ) = \frac{1}{( {\sum }_{j} {W}_{j} )} {W}_{m} \qquad ( 26 )$$

which forces the sum of the scaled regime weighting functions to equal a value of one everywhere in the parameter space {Λₖ}. If the regime weighting functions are not scaled in this way, the values will sum to less than one within some factor of ε near regime boundary transitions.

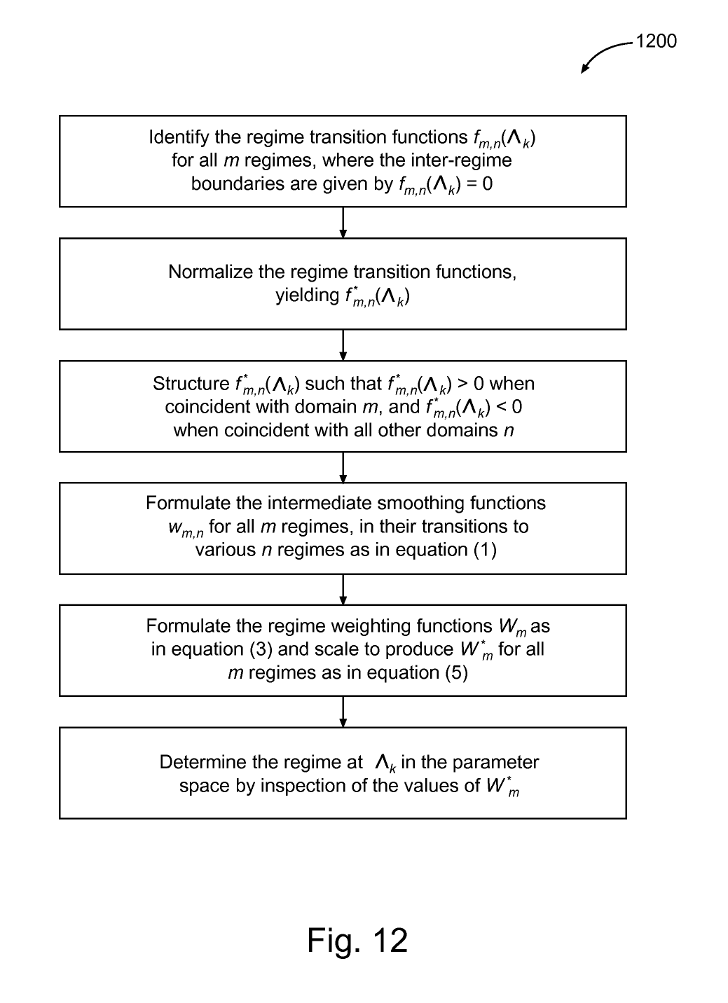

FIG. 12 is a flow diagram of a regime identification method 1200, according to various embodiments of the invention. Here the values of Wₘ* at a location Λₖ in the parameter space can be used directly to determine the existence of one or more regimes.

Within the boundary of a regime, its scaled regime weighting function Wₘ* will asymptotically approach the value of one. As a boundary is approached, the value of Wₘ* for that regime will decrease monotonically, attaining a value of 0.5 on the boundary. Outside of the boundary, but proximate to it, the scaled regime weighting function for the first considered regime will continue to decrease and asymptotically approach zero, while the scaled regime weighting function for the neighboring regime (into which the transition occurs) will smoothly increase to approach a value of one.

In this way, the regime(s) can be identified at any location Λₖ in the parameter space, simply by inspection of the values of Wₘ*. Thus, if Wₘ*>0.5, then the flow is occurring in the m^{th} regime. If W*=0.5 for two regimes, this indicates that Λₖ is on a boundary between the two regimes. If W*=1/3 for three regimes at a given location Λₖ, then a triple point is indicated, and so on.

Each regime may also be associated with descriptive parameters, such as pressure drops, friction factors, and convective heat transfer coefficients which are unique to that regime. These descriptive parameters may be empirically determined from experiments, or described by a reduced version of the governing equations of conservation of mass, momentum, and energy. Because of the incomplete information used to formulate such descriptive parameters, they often exhibit discontinuities at regime boundaries, leading to instabilities in simulation and control schemes. Using the various embodiments disclosed herein, a smoothed, regime-weighted descriptive parameter at any location throughout the parameter space can be found using the scaled regime weighting functions.

For example, various pressure drop relations exist for two-phase, gas-liquid flows in pipes. With some exceptions, such as transitions between stratified smooth and stratified wavy regimes, most crossings of regime boundaries are not continuous. In this case, the descriptive functions for the pressure drop (negative of the pressure gradient) in the downstream direction of the pipe, indicated by x, for various regimes, are given in Table VI.

TABLE VI

| Regime(s) | Pressure Drop Relation |
|---|---|
| dispersed bubble | $\frac{dP}{dx} {\vert}_{DB} = \frac{{τ}_{WDB}}{D} + {ρ}_{DB} g sin θ$ |
| stratified smooth or stratified wavy | $\begin{matrix}\frac{dP}{dx} {\vert}_{SS} = \frac{dP}{dx} {\vert}_{SW} = \\ [ {τ}_{WL} {S}_{L} + {τ}_{WG} {S}_{G} + ( {ρ}_{L} {A}_{L} + {ρ}_{G} {A}_{G} ) g sin θ ] / A\end{matrix}$ |
| annular | $\frac{dP}{dx} {\vert}_{AN} = [ {τ}_{WL} {S}_{W} + {τ}_{WG} {S}_{G} + ( {ρ}_{L} {A}_{F} + {ρ}_{C} {A}_{C} ) g sin θ ] / A$ |
| slug or elongated bubble | $\frac{dP}{dx} {\vert}_{SL} = {τ}_{S} πD \frac{{L}_{S}}{{AL}_{U}} + ( {τ}_{WF} {S}_{F} + {τ}_{WG} {S}_{G} ) \frac{{L}_{F}}{{AL}_{U}} + {ρ}_{U} g sin θ$ |
| bubble(y) | $\frac{dP}{dx} {\vert}_{B} = \frac{{τ}_{WB}}{D} + {ρ}_{B} g sin θ$ |
| churn | $\frac{dP}{dx} {\vert}_{CH} = \frac{{τ}_{WCH}}{D} + {ρ}_{CH} g sin θ$ |
| single-phase gas | $\frac{dP}{dx} {\vert}_{SPG} = \frac{{τ}_{WG}}{D} + {ρ}_{G} g sin θ$ |
| single-phase liquid | $\frac{dP}{dx} {\vert}_{SPL} = \frac{{τ}_{WL}}{D} + {ρ}_{L} g sin θ$ |
| quiescent mixture | $\frac{dP}{dx} {\vert}_{QM} = {ρ}_{QM} g sin θ$ |

Here, the values of density are calculated as appropriate for the regime (for example ρ_{DB} is calculated as a pseudo-single phase assuming no-slip between the dispersed bubbles and surrounding fluid matrix, ρ_{U} is the average density of the slug unit, ρ_{B} is a liquid-hold-up weighted average of the densities of the liquid and gas phases), the areas and interfacial perimeters are those appropriate to the geometry of the regime (for example in annular flow A_{I} is the interface area between the phases at a cross-section, and S_{I} is the interface perimeter between the phases at a cross-section), the friction factors and apparent or mixture velocities are modeled for the specific regime geometries, and the various forms of τ represent shear stresses which are modeled for the various phases present.

The smoothed pressure drop throughout the parameter space {Λₖ} is then given by

$$\frac{dP}{dx} ( {Λ}_{k} , ɛ ) = \frac{1}{( {\sum }_{k} {W}_{k} )} {\sum }_{m} {W}_{m} \frac{dp}{{dx}_{m}} ( {Λ}_{k} ) \qquad ( 27 )$$

for all m regimes. Note that the descriptive functions should be defined over the entire parameter space {Λₖ}, which can require special attention. A specific example of air and water flow in a pipe will now be presented.

### Example 3: Air and Water Flow in a Pipe

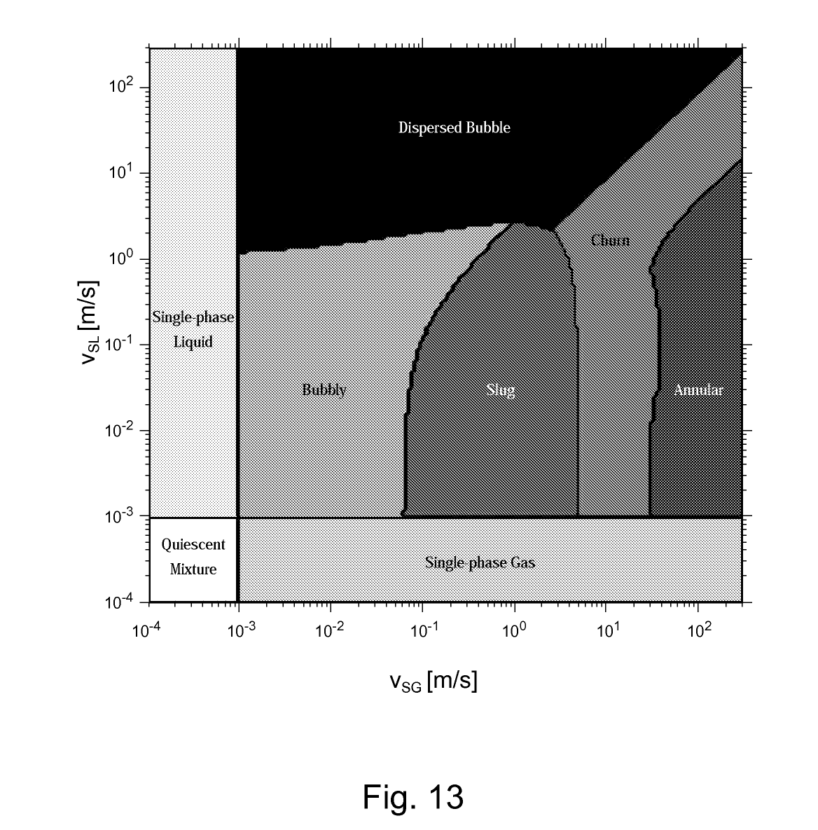

Consider a two-phase flow of air and water at 20° C. and one atmosphere of pressure, for a pipe with diameter D=10 cm, and various inclination angles. The remaining properties are taken to be ρ_{L}=998 kg/m³, ρ_{G}=1.204 kg/m³, μ_{L}=1.002×10⁻³ kg/m-s, μ_{G}=1.825×10⁼⁵ kg/m-s, σ_{L}=0.073 N/m, as the superficial velocities (v_{SL}, v_{SG}) of the liquid and gas are varied over ranges of 10⁻⁴≦v_{SL}≦300 m/s and 10⁻⁴≦v_{SG}≦300 m/s, respectively (with flow treated as if it remains subsonic) in a smooth pipe. An upward flow of θ=90° is shown in FIG. 13, which is a map 1300 in two-dimensional, regime-based parameter space, of multiple regimes, according to various embodiments of the invention. Here the regimes (stratified wavy, dispersed bubble, churn, and annular) are plotted over the superficial gas and liquid velocities.

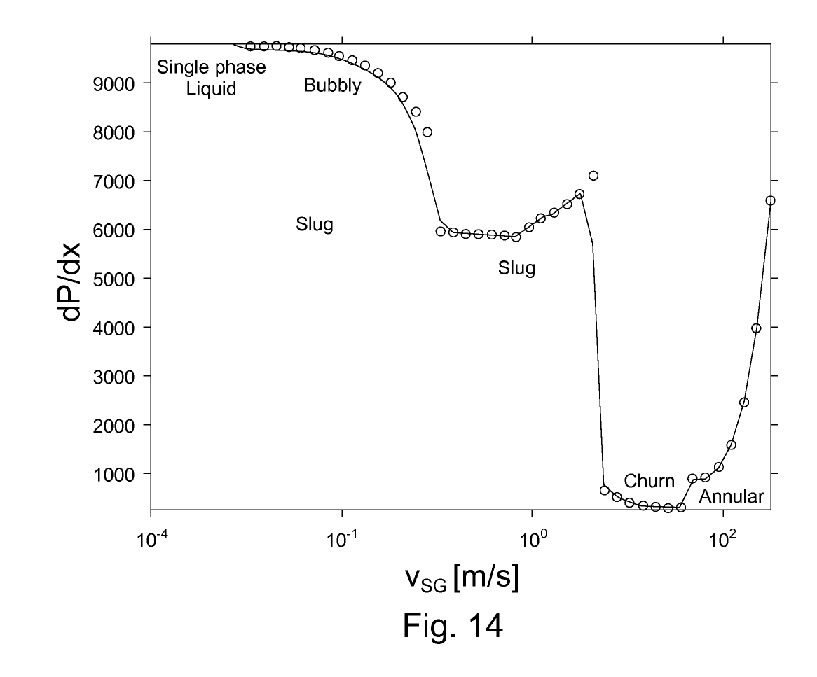

FIG. 14 illustrates the original and smoothed values 1410, 1420 for pressure drop across the regimes of FIG. 13, according to various embodiments of the invention. In this case, for a fixed value of v_{SL}=0.1 m/s, the pressure drop values 1410 and smoothed pressure drop values 1420 are indicated over a range of 10⁻⁴≦v_{SG}≦300. Open symbols (for values 1410) represent the original values of pressure drop and the solid line (for values 1420) represents the smoothed pressure drop. Both the discrete values (symbols) and the smoothed pressure drop (line) are plotted, per equation (27). As shown by the smoothed pressure drop (line), the discontinuous jumps in pressure drop, as the regime boundaries are crossed, have been eliminated. Many embodiments may thus be realized.

### Example 4: Integration with Physical Apparatus, Methods and Systems

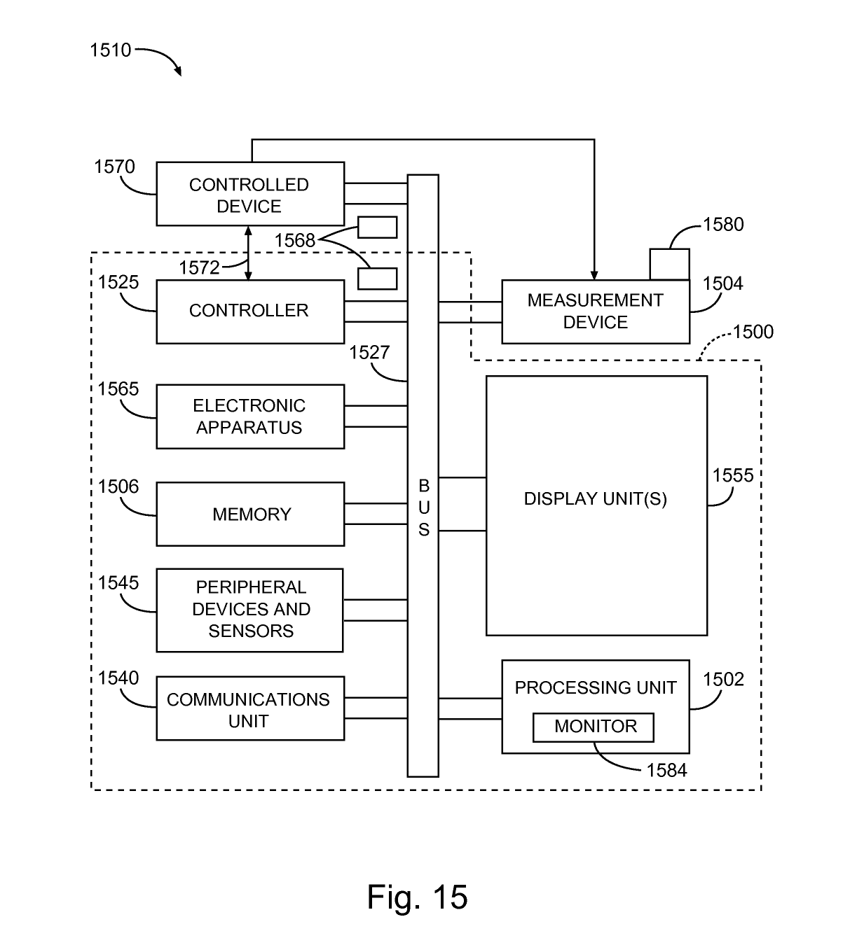

For example, FIG. 15 illustrates simulation and control apparatus 1500, and a control system 1510 according to various embodiments of the invention. The apparatus 1500 and system 1510 may form part of a laboratory flow simulator, a fluidized bed control system, a piping valve control system, and many others. In some embodiments, the apparatus 1500 and system 1510 are operable within a wellbore, or in conjunction with wireline and drilling operations, as will be discussed later.

In many embodiments, the apparatus 1500 and system 1500 can receive environmental measurement data via an external measurement device 1504 (e.g., a fluid parameter measurement device to measure temperature, pressure, flow velocity, and/or volume, etc.). Other peripheral devices and sensors 1545 may also contribute information to assist in the identification of flow regimes, and the simulation of various values that contribute to system operation.

The processing unit 1502 can perform smoothing functions and regime identification, among other functions, when executing instructions that carry out the methods described herein. These instructions may be stored in memory, such as the memory 1506. These instructions can transform a general purpose processor into the specific processing unit 1502 that can then be used to identify flow regimes, and generate control commands 1568. These commands 1568 can be supplied to the controlled device 1570 directly, via the bus 1527, or indirectly, via the controller 1525. In either case, commands 1568 and/or control signals 1572 are delivered to the controlled device 1570 in such a way as to effect changes in the structure and operation of the controlled device 1570 in a predictable and smooth fashion, even as the boundaries between flow regimes are crossed.

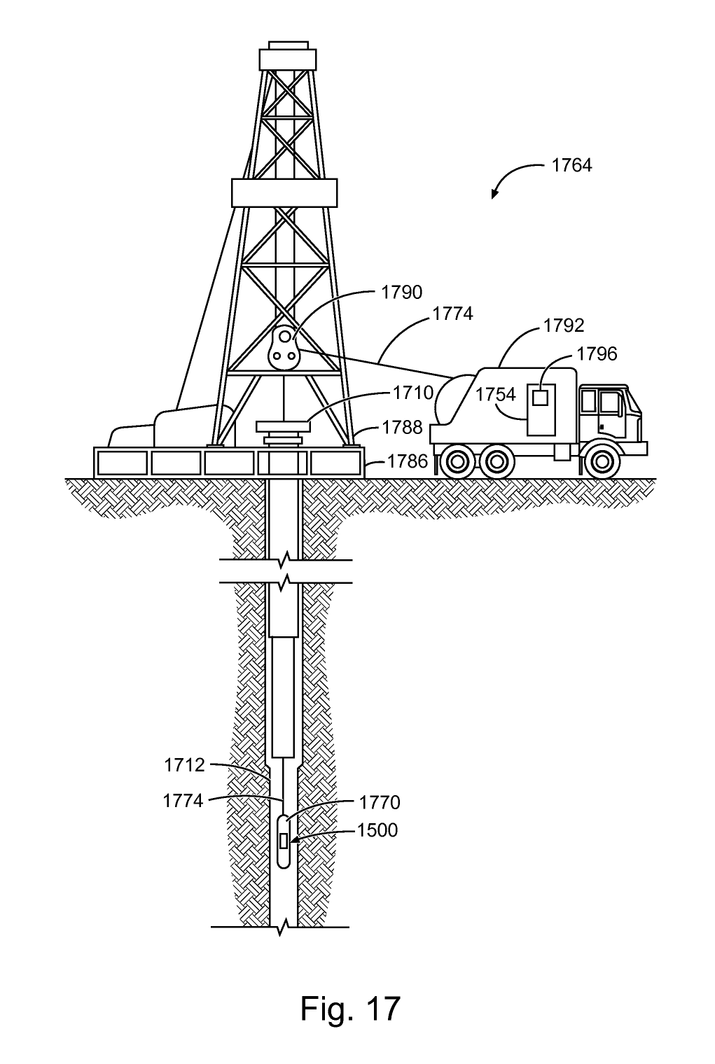

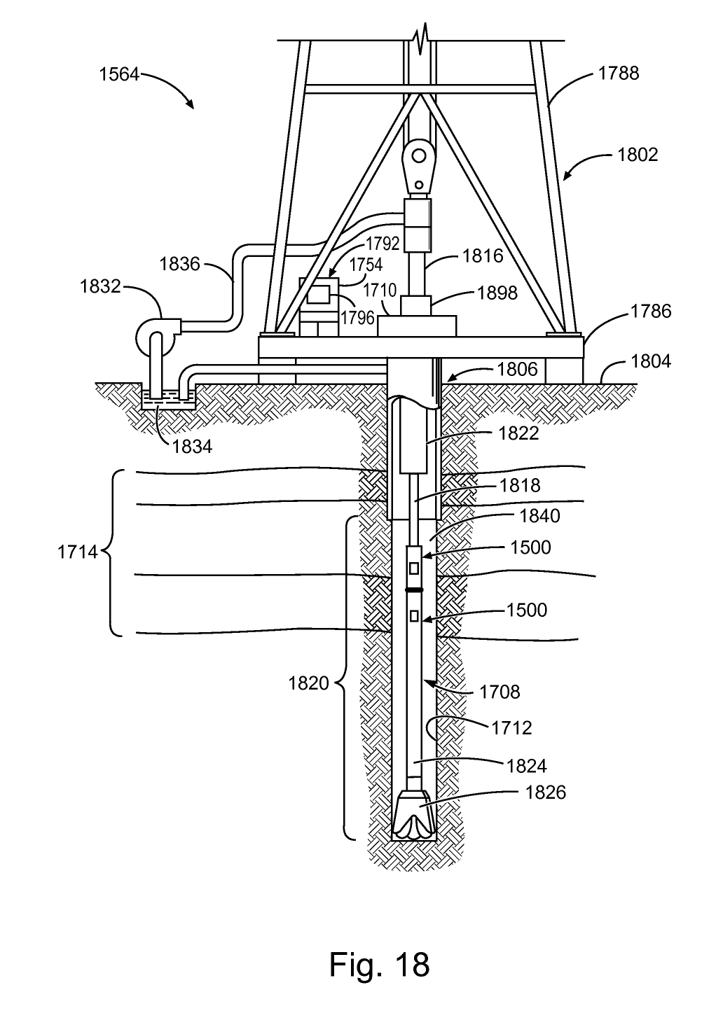

As will be described in more detail below, in some embodiments, a housing, such as a wireline tool body, or a downhole tool, can be used to house one or more components of the apparatus 1500 and system 1510, as described in more detail below with reference to FIGS. 17 and 18. The processing unit 1502 may be part of a surface workstation or attached to a downhole tool housing.

The apparatus 1500 and system 1510 can include other electronic apparatus 1565 (e.g., electrical and electromechanical valves and other types of actuators), and a communications unit 1540, perhaps comprising a telemetry receiver, transmitter, or transceiver. The controller 1525 and the processing unit 1502 can each be fabricated to operate the measurement device 1504 to acquire measurement data, including but not limited to measurements representing any of the physical parameters described herein. Thus, in some embodiments, such measurements are made within the physical world, and in others, such measurements are simulated. In many embodiments, physical parameter values are provided as a mixture of simulated values and measured values, taken from the real-world environment. The measurement device 1504 may be immersed directly within the flow, or attached to another element 1580 (e.g., a drill string, sonde, conduit, housing, or a container of some type) to sample flow characteristics as the flow passes by the device 1504.

The bus 1527 that may form part of an apparatus 1500 or system 1510 can be used to provide common electrical signal paths between any of the components shown in FIG. 15. The bus 1527 can include an address bus, a data bus, and a control bus, each independently configured. The bus 1527 can also use common conductive lines for providing one or more of address, data, or control, the use of which can be regulated by the processing unit 1502, and/or the controller 1525.

The bus 1527 can include circuitry forming part of a communication network. The bus 1527 can be configured such that the components of the system 1510 are distributed. Such distribution can be arranged between downhole components and components that can be disposed on the surface of the Earth. Alternatively, several of these components can be co-located, such as in or on one or more collars of a drill string or as part of a wireline structure.

In various embodiments, the apparatus 1500 and system 1510 includes peripheral devices, such as one or more displays 1555, additional storage memory, or other devices that may operate in conjunction with the controller 1525 or the processing unit 1502, such as a monitor 1584, which may operate within the confines of the processing unit 1502, or externally, perhaps coupled directly to the bus 1527.

The display 1555 can be used to display diagnostic information, measurement information, smoothing information, regime information, control system commands, as well as combinations of these, based on the signals generated and received, according to various method embodiments described herein. The monitor 1584 may be used to track the values of one or more measured flow parameters, simulated flow parameters, and regime proximity values to initiate an alarm or a signal that results in activating functions performed by the controller 1525 and/or the controlled device 1570.

In an embodiment, the controller 1525 can be fabricated to include one or more processors. The display 1555 can be fabricated or programmed to operate with instructions stored in the processing unit 1502 (and/or in the memory 1506) to implement a user interface to manage the operation of the apparatus 1500 or components distributed within the system 1510. This type of user interface can be operated in conjunction with the communications unit 1540 and the bus 1527. Various components of the system 1510 can be integrated with the apparatus 1500 or associated housing such that processing identical to or similar to the methods discussed with respect to various embodiments herein can be performed downhole.

In various embodiments, a non-transitory machine-readable storage device can comprise instructions stored thereon, which, when performed by a machine, cause the machine to become a customized, particular machine that performs operations comprising one or more features similar to or identical to those described with respect to the methods and techniques described herein. A machine-readable storage device, herein, is a physical device that stores information (e.g., instructions, data), which when performed, alters the physical structure of the device. Examples of machine-readable storage devices can include, but are not limited to, memory 1506 in the form of read only memory (ROM), random access memory (RAM), a magnetic disk storage device, an optical storage device, a flash memory, and other electronic, magnetic, or optical memory devices, including combinations thereof.

The physical structure of stored instructions may be operated on by one or more processors such as, for example, the processing unit 1502. Operating on these physical structures can cause the machine to perform operations according to methods described herein. The instructions can include instructions to cause the processing unit 1502 to store associated data or other data in the memory 1506. The memory 1506 can store the results of measurements of fluid, formation, and other parameters. The memory 1506 can store a log of measurements that have been made. The memory 1506 therefore may include a database, for example a relational database. Thus, still further embodiments may be realized.

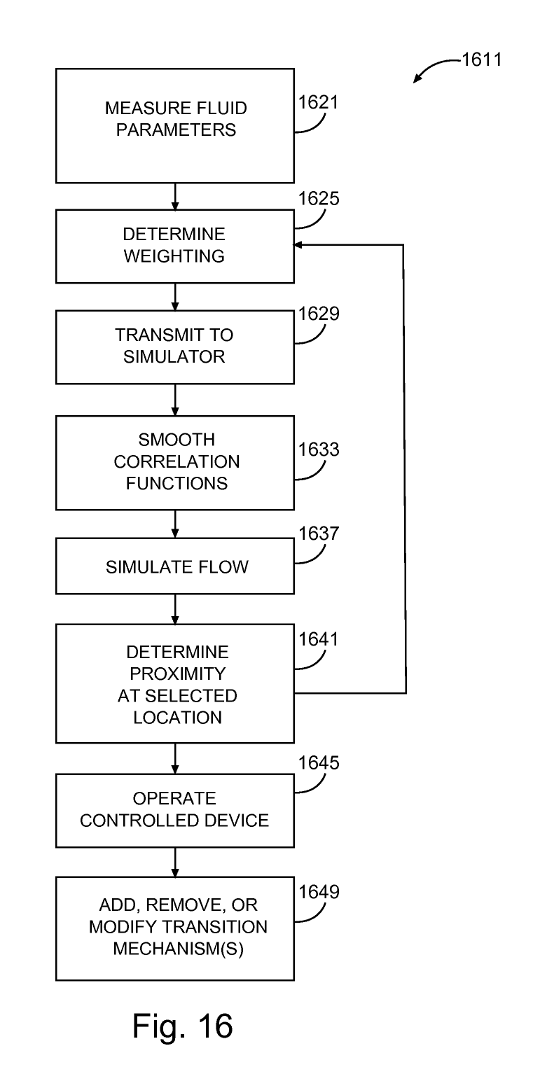

For example, FIG. 16 is a flow diagram illustrating methods 1611 of identifying regimes, and smoothing discontinuities between them, according to various embodiments of the invention. The methods 1611 described herein include and build upon the methods, apparatus, systems, and information illustrated in FIGS. 1-15. Some operations of the methods 1611 can be performed in whole or in part by the feedback control processing unit 1502, the apparatus 1500, and the system 1510, or any component thereof (FIG. 15).

Thus, referring now to FIGS. 1, 12, and 16, it can be seen that in some embodiments, a method comprises selecting a location in a fluid flow at which one or more physical properties can be measured. Using the measured values, simulation may be performed to determine other (non-measured) values for that location. In this way, parameter measurements can be combined with simulations to determine the values of additional parameters. Finally, the proximity to regime transition zones at the location can be determined, and the operation of an electrical or mechanical device can be affected, as a result. This type of process can be quite useful for monitoring and improving the operations of physical systems, to control their operations in a predictable manner as regime boundaries change within the flow.

In some embodiments, after a measurement or monitoring location is selected, and one or more fluid property measurement devices are installed to make measurements, a method 1611 begins with measuring physical parameter values associated with the fluid flow at the selected location, at block 1621. For example, the location for measurement or monitoring might be a convenient access point along a pipeline, such as an oil or gas pipeline, or a chemical plant processing pipeline. Thus, the location may comprise an access port in a pipeline, among others.

The method 1611 may continue on to block 1625, to determine the continuous parameter space weighting function values associated with the location. The weighting functions that provide these values are established via the methods shown in FIGS. 1 and 12, described previously.

Once the function values have been determined, they may be communicated to a variety of locations, including a processing unit, a controller, and/or a simulator, such as a piping simulator. Thus, in some embodiments, the continuous parameter space weighting values might be transmitted to a piping simulator program for further analysis and processing, at block 1629.

Smoothing can be used to provide stable, accurate simulation and control systems, since discontinuities do not exist over the operational space. Thus, the method 1611 may continue on to block 1633 to include smoothing correlation functions, such as pressure drop correlation functions, over transition areas between different flow regimes to provide smoothed pressure drop value dependencies based on the weighting functions that determine relative boundaries of the flow regimes in the parametric space of the flow.

Different descriptive parameters, and the behavior of fluids associated with them, may be monitored, and controlled—in real time, or predictively. Thus, the smoothing activity at block 1633 may be applied to additional descriptive parameters, including at least one of heat transfer or vibration analysis.

At this point, the method 1611 may include, at block 1637, simulation of the measured or monitored system, or a portion of the system, to provide values for fluid flow parameters that have not been measured, but may be inferred from the characteristics of the system, such as its physical properties, environmental conditions, and the values of parameters that have been measured.

The method 1611 may continue on to block 1641 to determine proximity to fluid flow regime transition zones at the selected location in the fluid flow, based on the continuous parameter space weighting function values associated with the location, and physical parameter values associated with the fluid flow at the location that are determined by at least one of measurement or simulation. As a result, the activity at block 1641 may comprise determining proximity to the fluid flow regime transition zones based on numerical simulator predictions with available measured or specified flow parameters and predicted values (e.g., as provided by a simulator) of the continuous parameter space weighting functions associated with the flow regimes at different locations.

Fluid flow may exist as a contained internal fluid flow in a variety of physical settings. Thus, measured and/or monitored fluid flow may be contained by, and occur within a pipe, conduit, a fluidized bed container, or within a well bore of a geological formation.

A scaled version of the continuous parameter space weighting function values can be used to determine the proximity to the fluid flow regime transition zones. Thus, the proximity may be determined directly by a scaled version of the continuous parameter space weighting function values (e.g., see FIG. 12).

The method 1611 may continue on to block 1645 and operate a controlled device based on the proximity to a selected one of fluid flow regimes defined by the fluid flow regime transition zones. The controlled device might include one or more electrical devices (e.g., a solenoid, a switch, a transistor, or an input/output port) or mechanical devices (e.g., a valve, a linear actuator, or a rotary actuator).

The regimes can be any one or more of several identified regimes. Thus, one or more regimes may be selected as a quiescent mixture, a single-phase gas, a single-phase liquid, a dispersed bubble regime, a stratified smooth regime, a stratified wavy regime, an annular regime, a slug regime, a churn regime, an elongated bubble regime, or a bubbly regime.

The activity at block 1645 may alternatively or further include operating a controlled device based on the smoothed pressure drop value at a selected location within a fluid flow associated with the flow parametric space.

The method 1611 can accommodate additional transition functions. Thus, the method 1611 may continue on to block 1649 to include adding, removing, or modifying regime transition functions without introducing discontinuities into pressure drop correlation functions (or other correlation functions) that define value dependencies, such as smoothed pressure drop value dependencies.

It should be noted that the methods described herein do not have to be executed in the order described, or in any particular order. Moreover, various activities described with respect to the methods identified herein can be executed in iterative, serial, or parallel fashion. Information, including parameters, commands, operands, and other data, can be sent and received in the form of one or more carrier waves.

For example, the method of 1611 may be executed iteratively for cases where limited measurement data is available, with a feedback loop between block 1641 and block 1625, where the initial weighting in block 1625 is an approximation which is improved and iterated upon. Loops may also be executed between other blocks in the method of 1611, depending on the measurement and simulation capabilities.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. For example, the programs may be structured in an object-orientated format using an object-oriented language such as Java or C#. In another example, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, as described earlier herein, simulators and control systems can be used in combination with a logging-while-drilling (LWD) or measurement—while drilling (MWD) assembly or a wireline logging tool. FIG. 17 depicts an example system 1510 in the form of a wireline system, according to various embodiments of the invention. FIG. 18 depicts an example system 1510, in the form of a drilling system, according to various embodiments of the invention.

Either of the systems 1510 in FIGS. 17 and 18 are operable in conjunction with the apparatus 1500 to conduct measurements in a wellbore, to determine the existence and proximity to flow regimes therein, and to change operations accordingly. Thus, the systems 1510 may comprise portions of a wireline logging tool body 1770 as part of a wireline logging operation, or of a downhole tool 1824 (e.g., a drilling operations tool) as part of a downhole drilling operation.

Returning now to FIG. 17, a well during wireline logging operations can be seen. In this case, a drilling platform 1786 is equipped with a derrick 1788 that supports a hoist 1790.

Drilling oil and gas wells is commonly carried out using a string of drill pipes connected together so as to form a drilling string that is lowered through a rotary table 1710 into a wellbore or borehole 1712. Here it is assumed that the drilling string has been temporarily removed from the borehole 1712 to allow a wireline logging tool body 1770, such as a probe or sonde, to be lowered by wireline or logging cable 1774 into the borehole 1712. Typically, the wireline logging tool body 1770 is lowered to the bottom of the region of interest and subsequently pulled upward at an approximately constant speed.

During the upward trip, at a series of depths, the instruments (e.g., the apparatus 1500 shown in FIG. 15) included in the tool body 1770 may be used to perform measurements on the subsurface geological formations adjacent the borehole 1712 (and the tool body 1770). The measurement data can be communicated to a surface logging facility 1792 for storage, processing, and analysis. The logging facility 1792 may be provided with electronic equipment for various types of signal processing, including any of the apparatus described herein. Similar formation evaluation data may be gathered and analyzed during drilling operations (e.g., during LWD operations, and by extension, sampling while drilling and MWD).

In some embodiments, the tool body 1770 comprises an apparatus 1500 for obtaining and analyzing measurements in a subterranean formation through a borehole 1712. The tool is suspended in the wellbore by a wireline cable 1774 that connects the tool to a surface control unit (e.g., comprising a workstation 1754, which can also include a display). The tool may be deployed in the borehole 1712 on coiled tubing, jointed drill pipe, hard wired drill pipe, or any other suitable deployment technique.

Turning now to FIG. 18, it can be seen how a system 1510 may also form a portion of a drilling rig 1802 located at the surface 1804 of a well 1806. The drilling rig 1802 may provide support for a drill string 1898. The drill string 1898 may operate to penetrate the rotary table 1710 for drilling the borehole 1712 through the subsurface formations 1714. The drill string 1898 may include a Kelly 1816, drill pipe 1818, and a bottom hole assembly 1820, perhaps located at the lower portion of the drill pipe 1818.

The bottom hole assembly 1820 may include drill collars 1822, a downhole tool 1824, and a drill bit 1826. The drill bit 1826 may operate to create the borehole 1712 by penetrating the surface 1804 and the subsurface formations 1714. The downhole tool 1824 may comprise any of a number of different types of tools including MWD tools, LWD tools, and others.

During drilling operations, the drill string 1898 (perhaps including the Kelly 1816, the drill pipe 1818, and the bottom hole assembly 1820) may be rotated by the rotary table 1710. Although not shown, in addition to, or alternatively, the bottom hole assembly 1820 may also be rotated by a motor (e.g., a mud motor) that is located downhole. The drill collars 1822 may be used to add weight to the drill bit 1826. The drill collars 1822 may also operate to stiffen the bottom hole assembly 1820, allowing the bottom hole assembly 1820 to transfer the added weight to the drill bit 1826, and in turn, to assist the drill bit 1826 in penetrating the surface 1804 and subsurface formations 1714.

During drilling operations, a mud pump 1832 may pump drilling fluid (sometimes known by those of ordinary skill in the art as “drilling mud”) from a mud pit 1834 through a hose 1836 into the drill pipe 1818 and down to the drill bit 1826. The drilling fluid can flow out from the drill bit 1826 and be returned to the surface 1804 through an annular area 1840 between the drill pipe 1818 and the sides of the borehole 1712. The drilling fluid may then be returned to the mud pit 1834, where such fluid is filtered. In some embodiments, the drilling fluid can be used to cool the drill bit 1826, as well as to provide lubrication for the drill bit 1826 during drilling operations. Additionally, the drilling fluid may be used to remove subsurface formation cuttings created by operating the drill bit 1826.

Thus, it may be seen that in some embodiments, the systems 1510 may include a drill collar 1822, a downhole tool 1824, and/or a wireline logging tool body 1770 to house one or more apparatus 1500, similar to or identical to the apparatus 1500 described above and illustrated in FIG. 15.

Thus, for the purposes of this document, the term “housing” may include any one or more of a drill collar 1822, a downhole tool 1824, or a wireline logging tool body 1770 (all having an outer wall, to enclose or attach to magnetometers, sensors, fluid sampling devices, pressure measurement devices, transmitters, receivers, acquisition and processing logic, and data acquisition systems). The tool 1824 may comprise a downhole tool, such as an LWD tool or MWD tool. The wireline tool body 1770 may comprise a wireline logging tool, including a probe or sonde, for example, coupled to a logging cable 1774. For example, a system 1510 may comprise a downhole tool body, such as a wireline logging tool body 1770 or a downhole tool 1824 (e.g., an LWD or MWD tool body), and one or more apparatus 1500 attached to the tool body, the apparatus 1500 to be constructed and operated as described previously. Many embodiments may thus be realized.

Any of the above components, for example the apparatus 1500 (and each of its elements), and the systems 1510 (and each of their elements) may all be characterized as “modules” herein. Such modules may include hardware circuitry, and/or a processor and/or memory circuits, software program modules and objects, and/or firmware, and combinations thereof, as desired by the architect of the apparatus 1500 and systems 1510, and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, a measured radiation simulation package, a fluid flow simulation package, and/or a combination of software and hardware used to simulate the operation of various potential embodiments.

It should also be understood that the apparatus and systems of various embodiments can be used in applications other than for logging operations, and thus, various embodiments are not to be so limited. The illustrations of apparatus 1500 and systems 1510 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules. Thus, many embodiments may be realized.

For example, referring now to FIGS. 15-18, it can be seen that a system 1510 may comprise one or more fluid parameter measurement devices 1504, a processing unit 1502 to determine fluid flow regime transition zone proximity, and an actuator (e.g., the controller 1525) to effect control over a device 1570. In this way, one or more flow properties can be measured, others can be simulated, and then control commands 1568 can be formulated to affect the operation of a controlled device 1570.

In some embodiments, a system 1510 comprises at least one fluid parameter measurement device 1504 to provide a measured value of at least one property of a fluid at a location within a flow of the fluid. The system 1510 may further include a processing unit 1502 to determine proximity to fluid flow regime transition zones at the location based on at least one of the measured value or numerical simulator predictions associated with the measured value, and continuous parameter space weighting function values associated with the location. The system 1510 may also include one or more controlled devices 1570 to operate in response to a value of the proximity to selected fluid flow regime(s) in the flow, or to a smoothed pressure drop value at the location.

The fluid parameter measurement device may be attached to piping, within a chemical processing plant, downhole, etc.; a downhole logging tool; or a fluidized bed container. Thus, in some embodiments, a system 1510 may include an element 1580 attached to the fluid parameter measurement device 1504, such as a pipe, a downhole logging tool, or a fluidized bed container. In some embodiments, the system 1510 may comprise additional elements 1580 attached to the fluid parameter measurement device 1504, such as a container to contain a portion of the fluid in a pipe, conduit, or wellbore.

The system may incorporate a programmable logic controller that operates valves and other devices, to control the fluid flow based on the proximity to the fluid flow regime transition zones. Thus, in some embodiments, the system 1510 may comprise at least one valve (e.g., as a controlled device 1570) electrically coupled to a programmable logic controller (e.g., as a controller 1525), to control the flow of the fluid.

A number of controlled devices may operate within the system, according to regime proximity, or the smoothed pressure drop. One such device is a slug catcher that may be put into operation when the proximity to a slug flow regime exceeds a threshold value. Thus, in some embodiments of the system 1510, the controlled device 1570 comprises a slug catcher to be activated when the proximity to a slug flow regime exceeds a preselected threshold value.

A pump on the surface may be controlled by the processing unit, according to the proximity to various fluid flow transition regimes. Power to the pump and thus the flow rate can be controlled by the processing unit or the controller according to the proximity to the dispersed bubble or bubbly regimes, relative to the proximity of the intermittent regimes (slug, elongated bubble, and churn), perhaps avoiding the latter to maintain uninterrupted flow and provide sufficient cooling to the pump in an oil well. Thus, in some embodiments of the system 1510, the controlled device 1570 comprises an external pump to transport the fluid.

The fluid parameter measurement device may include a number of different device types. Thus, in some embodiments of the system 1510, the fluid parameter measurement device 1504 comprises one or more of a density measurement device, a pressure measurement device, a flow rate measurement device, or a temperature measurement device.

The fluid parameter measurement device can be attached to a wireline logging tool. To improve the technology used to recover fluid from an oil well, proximity determination can be used to facilitate optimal operation. Thus, some embodiments of the system 1510 comprise a wireline probe (e.g., as a wireline logging tool body 1770) attached to the fluid parameter measurement device 1504, wherein the controlled device 1570 is to be operated to avoid dispersed bubble or bubbly flows based on the proximity, in favor of the proximity to single-phase liquid, to reduce the release of gas from liquid oil in the well.

The fluid parameter measurement device can be attached to a drill string. The measured/calculated proximity to a desired flow regime can then be used to encourage optimal well operating conditions. Thus, some embodiments of the system 1510 comprise a drill string 1898 attached to the fluid parameter measurement device 1504, wherein the controlled device 1570 is to be operated to avoid the proximity to bubble, slug, or churn flow in favor of annular or single-phase gas to minimize water cut in a gas well.

In some embodiments of the system 1510, the controlled device 1570 comprises an electric pump that is to be operated to avoid proximity to bubbly or slug flow in favor of dispersed bubble or single-phase liquid to reduce probability of gas locking in an oil well.

In some embodiments of the system 1510, the controlled device 1570 comprises a sucker rod that is to be operated to avoid the proximity of bubbly, slug, elongated bubble, or churn flow, in favor of dispersed bubble or single-phase liquid in an oil well.

In some embodiments of the system 1510, the controlled device 1570 comprises a separator that is to be operated to avoid the proximity of intermittent slug, elongated bubble, or churn regimes in favor of stratified smooth or stratified wavy flow regimes to reduce dwell time in the separator.

Some regimes of operation can be avoided in favor of other regimes, to provide favorable operating conditions, such as improving the operational efficiency of technology. Thus, in some embodiments, selected regimes are maintained for more efficient operation. For example, some embodiments are configured to maintain single-phase flow, or any other desired regime that is useful in a particular application, such as churn flow (e.g., where a mixing process is desired).

Many embodiments may thus be realized. For example, in some embodiments of the system 1510, the controlled device 1570 comprises a choke to be operated to maintain a selected one of the fluid flow regimes. In some embodiments of the system 1510, the controlled device 1570 comprises a downhole inflow control device that is to be operated to avoid the proximity of annular flow in favor of single-phase gas in a gas well.

Flow assurance issues within a piping system can also be addressed with the application of the methods, apparatus, and systems described herein. Control conditions can be selected and/or alarms can be set based on the proximity to problematic flow conditions related to specific flow assurance situations. Thus, in some embodiments, a fluid transport piping system 1510 comprises an element 1580, such as a fluid conduit, coupled to at least one fluid parameter measurement device 1504 to measure at least one property of fluid flow at a location in the fluid conduit. The system 1510 may further include a controlled device 1570 comprising a pump or a valve to control the fluid flow, as directed by a processing unit 1502 having access to a numerical model of the fluid flow and at least one property of the fluid flow, based on proximity to fluid flow regime transition zones at the location and continuous parameter space weighting function values associated with the location, wherein the fluid flow regime transition zones define a set of fluid flow regimes.

In some embodiments that operate to address flow assurance issues, particulate erosion can occur when less damaging flow regimes are not maintained. Thus, a system 1510 may comprise a monitor 1584 to indicate erosion of the fluid conduit due to particulate transport when transition to an intermittent regime is not avoided in favor of a stratified wavy regime or a stratified smooth regime.

In some embodiments that operate to address flow assurance issues, particulate deposition may be avoided by maintaining selected regimes. Thus, a system 1510 may comprise a monitor 1584 to indicate particulate deposition in the fluid conduit when a stratified wavy regime or a stratified smooth regime is not avoided in favor of an intermittent regime.

In some embodiments that operate to address flow assurance issues, hydrate formation and/or wax buildup can occur when an unexpected regime is entered. Thus, a system 1510 may comprise a monitor 1584 to indicate an unexpected transition from a first one of the regimes to a second one of the regimes.

In some embodiments that operate to address flow assurance issues, monitoring and alarming on close proximity to slug, elongated bubble, or churn regimes is employed. This may avoid excessive vibration, perhaps associated with fatigue failure. In this way, system life may be extended by changing operating conditions to maintain single-phase flow, or another two-phase flow regime (e.g., annular, stratified smooth, stratified wavy, dispersed bubble or bubbly). Thus, a system 1510 may comprise a monitor 1584 to indicate proximity to an intermittent one of the regimes as a prelude to a system failure mode.

Another embodiment of a system may include a borehole, one or more fluid parameter measurement devices, and a processing unit to determine fluid flow regime transition zone proximity. Again, one or more measurements, coupled with simulation, provide a powerful adjunct to a control system in this set of circumstances. Thus, in some embodiments, a fluid recovery system 1510 comprises a borehole 1712 to recover fluid located within a geological reservoir, which may in turn be located in a subsurface formation 1714. The system 1510 may further include at least one fluid parameter measurement device 1504 to measure at least one property of the fluid as a measured value at a location within the borehole 1712, and a processing unit 1502 to determine proximity to fluid flow regime transition zones at the location based on the measured value and continuous parameter space weighting function values associated with the location and a numerical model used for describing fluid flow within the borehole 1712.

Many advantages can be gained by implementing the methods, apparatus, and systems described herein. For example, two-phase, gas-liquid pipe flow regime-identification methods can provide scaled regime weighting functions Wₘ* for every regime at any location in the fundamental, independent parameter space. This gives great flexibility and extensive information. That is, such methods not only serve to identify the regime that exists at a particular location, but they can also inform an operator or control system when neighboring regimes are in close proximity, within the chosen parameter space. In comparison, existing algorithms are inflexible and cannot directly predict the proximity of neighboring regimes.

Efficiency and flexibility are also provided by many embodiments. For example, two-phase, gas-liquid pipe flow regime-identification methods may now include the computation of the scaled regime weighting functions Wₘ* that are explicit, with minimal logic requirements, with respect to a known set of regime transition functions. As such, new regime transition functions can be added with minimal or no impact on the structure of the regime identification methodology. That is, the same embodiment of a method can be used with different regime transition functions to account for new or different physical mechanisms, such as those occurring in annuli rather than pipes. In comparison, conventional mechanisms may require significant modification when a new regime transition function is added.

The methods described herein permit algorithmically simple and smooth interpolation of physical properties and descriptive flow parameters, such as pressure drop and heat transfer coefficients, over the entire space of the fundamental parameters which determine the system. In comparison, existing smoothing procedures rely on ad hoc arguments that typically are modified for each additional derived parameter that requires smoothing.

Because the smoothing is tied to a fundamental parameter space in most embodiments, extension to more complex fluids, such as non-Newtonian and multiphase fluids, including liquid-liquid, liquid-solid, gas-solid and three-phase or four-phase flows, is straightforward. The fundamental parameters need only be replaced by their non-Newtonian values. In comparison, existing methods treat the smoothing on a transition-by-transition basis, and thus rely on additional physical arguments. Thus, for each additional complex fluid used, the arguments for conventional methods must be revised to provide the same quality of smoothing.

Therefore, one of the hallmarks of the various embodiments described is their general applicability. The methods, apparatus, and systems are relevant to any modeling where discontinuities appear due to, for example, i) insufficient descriptions of the physics or governing mechanisms necessary to remove any non-physical discontinuities, ii) deliberate simplification of the physics or mechanisms to yield tractable models which can be solved on reasonable time-scales, and iii) unintentional failure to capture the complete set of physical relationships that describe a particular system, resulting in unexpected discontinuities.

Specifically, most, if not all, multiphase flow solvers suffer from discontinuities when transitions in the flow regime occur. Conventional smoothing procedures rely on a combination of ad hoc mechanistic arguments and piecewise smoothing in the physical space, making the algorithms highly specialized for certain fluids in certain thermodynamic states. Smoothing in the embodiments described herein occurs in parametric space, independent of the specific numerical implementation. Numerical models that make use of the disclosed embodiments then involve only continuous functions. The various embodiments can thus be applied to any combination of fluids (liquid, gas), and solid particulate, and any number of phases, making it applicable to any multiphase simulation software or control system.

In summary, using the apparatus, systems, and methods disclosed herein may provide improved computational efficiency and reliability, since explicit calculations are used to smooth known regime transition functions. This capability in turn serves to improve the speed and reliability of simulators and control systems, especially when discontinuities are present. These advantages can significantly enhance the value of the services provided in many industries, including those provided by an operation/exploration company or an oilfield service company, helping to reduce time-related costs and system failures, and increase customer satisfaction.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although specific embodiments have been illustrated and described herein, it will be appreciated by those of ordinary skill in the art that any arrangement that is calculated to achieve the same purpose may be substituted for the specific embodiments shown. Various embodiments use permutations or combinations of embodiments described herein. It is to be understood that the above description is intended to be illustrative, and not restrictive, and that the phraseology or terminology employed herein is for the purpose of description. Combinations of the above embodiments and other embodiments will be apparent to those of ordinary skill in the art upon studying the above description.

What is claimed is:

1. A method comprising:
determining proximity to fluid flow regime transition zones at a location in a contained fluid flow based on continuous parameter space weighting function values associated with the location, and physical parameter values associated with the fluid flow at the location that are determined by at least one of measurement or simulation; and
operating a controlled device based on the proximity to a selected one of fluid flow regimes defined by the fluid flow regime transition zones.

2. The method of claim 1, wherein the selected one of the fluid flow regimes comprises a quiescent mixture, a single-phase gas, a single-phase liquid, a dispersed bubble regime, a stratified smooth regime, a stratified wavy regime, an annular regime, a slug regime, a churn regime, an elongated bubble regime, or a bubbly regime.

3. The method of claim 1, wherein the contained fluid flow occurs within a pipe, conduit, a fluidized bed container, or within a well bore of a geological formation.

4. The method of claim 1, wherein the location comprises an access port in a pipeline.

5. The method of claim 1, wherein the proximity is determined directly by a scaled version of the continuous parameter space weighting function values.

6. The method of claim 1, wherein the operating comprises:
operating the controlled device comprising one of a solenoid, a switch, a transistor, or an input/output port.

7. The method of claim 1, wherein the operating comprises:
operating the controlled device as one of a valve, a linear actuator, or a rotary actuator.

8. The method of claim 1, further comprising:
transmitting the continuous parameter space weighting values to a piping simulator program.

9. The method of claim 1, wherein the determining further comprises:
determining proximity to the fluid flow regime transition zones based on numerical simulator predictions with available measured or specified flow parameters and predicted values of the continuous parameter space weighting functions associated with the flow regimes at different locations.

10. A method, comprising:
smoothing pressure drop correlation functions over transition areas between different flow regimes to provide smoothed pressure drop value dependencies based on weighting functions that determine relative boundaries of the flow regimes in flow parametric space; and
operating a controlled device based on the smoothed pressure drop value at a selected location within a fluid flow associated with the flow parametric space.

11. The method of claim 10, wherein regime transition mechanisms can be modified, added, or removed without introducing discontinuities into the pressure drop correlation functions that define the smoothed pressure drop value dependencies.

12. The method of claim 10, wherein the smoothing is applied to heat transfer coefficients in corresponding regimes.

13. A system, comprising:
at least one fluid parameter measurement device to provide a measured value of at least one property of a fluid at a location within a flow of the fluid;
a processing unit to determine proximity to fluid flow regime transition zones at the location based on at least one of the measured value or numerical simulator predictions associated with the measured value, and continuous parameter space weighting function values associated with the location; and
a controlled device to operate responsive to a value of the proximity to a selected one of fluid flow regimes in the flow, or to a smoothed pressure drop value at the location.

14. The system of claim 13, further comprising:
a pipe attached to the fluid parameter measurement device.

15. The system of claim 13, further comprising:
a downhole logging tool attached to the fluid parameter measurement device.

16. The system of claim 13, further comprising:
a fluidized bed container attached to the fluid parameter measurement device.

17. The system of claim 13, further comprising:
a container attached to the fluid parameter measurement device, the container to contain a portion of the fluid in a pipe, conduit, or wellbore.

18. The system of claim 13, further comprising:
at least one valve electrically coupled to a programmable logic controller, to control the flow of the fluid.

19. The system of claim 13, wherein the continuous parameter space weighting function values are guaranteed to sum to a selected value everywhere in a selected parameter space.

20. The system of claim 13, wherein the controlled device comprises a slug catcher to be activated when the proximity to a slug flow regime exceeds a preselected threshold value.

21. The system of claim 13, wherein the controlled device comprises an external pump to transport the fluid.

22. The system of claim 13, wherein the fluid parameter measurement device comprises one or more of a density measurement device, a pressure measurement device, a flow rate measurement device, or a temperature measurement device.

23. The system of claim 13, further comprising:
a wireline probe attached to the fluid parameter measurement device, wherein the controlled device is to be operated to avoid dispersed bubble or bubbly flows based on the proximity, in favor of the proximity to single-phase liquid, to reduce the release of gas from liquid oil in the well.

24. The system of claim 13, further comprising:
a drill string attached to the fluid parameter measurement device, wherein the controlled device is to be operated to avoid the proximity to bubble, slug, or churn flow in favor of annular or single-phase gas to minimize water cut in a gas well.

25. The system of claim 13, wherein the controlled device comprises an electric pump that is to be operated to avoid proximity to bubbly or slug flow in favor of dispersed bubble or single-phase liquid to reduce probability of gas locking in an oil well.

26. The system of claim 13, wherein the controlled device comprises a sucker rod that is to be operated to avoid the proximity of bubbly, slug, elongated bubble, or churn flow, in favor of dispersed bubble or single-phase liquid in an oil well.

27. The system of claim 13, wherein the controlled device comprises a separator that is to be operated to avoid the proximity of intermittent slug, elongated bubble, or churn regimes in favor of stratified smooth or stratified wavy flow regimes to reduce dwell time in the separator.

28. The system of claim 13, wherein the controlled device comprises a choke to be operated to maintain a selected one of the fluid flow regimes.

29. The system of claim 13, wherein the controlled device comprises a downhole inflow control device that is to be operated to avoid the proximity of annular flow in favor of single-phase gas in a gas well to minimize water production.

30. A fluid transport piping system, comprising:
a fluid conduit coupled to at least one fluid parameter measurement device to measure at least one property of fluid flow at a location in the fluid conduit; and
a controlled device comprising a pump or a valve to control the fluid flow, as directed by a processing unit having access to a numerical model of the fluid flow and the at least one property of the fluid flow, based on proximity to fluid flow regime transition zones at the location and continuous parameter space weighting function values associated with the location, wherein the fluid flow regime transition zones define a set of fluid flow regimes.

31. The system of claim 30, further comprising:
a monitor to indicate erosion of the fluid conduit due to particulate transport where transition to an intermittent (slug, elongated bubble or churn) regime is not avoided in favor of a stratified wavy regime or a stratified smooth regime.

32. The system of claim 30, further comprising:
a monitor to indicate particulate deposition in the fluid conduit when a stratified wavy regime or a stratified smooth regime is not avoided in favor of an intermittent (slug, elongated bubble or churn) regime.

33. The system of claim 30, further comprising:
a monitor to indicate an unexpected transition from a first one of the regimes to a second one of the regimes.

34. The system of claim 30, further comprising:
a monitor to indicate proximity to an intermittent one of the regimes as a prelude to a system failure mode.

35. A fluid recovery system, comprising:
a borehole to recover fluid located within a geological reservoir;
at least one fluid parameter measurement device to measure at least one property of the fluid as a measured value at a location within the borehole; and
a processing unit to determine proximity to fluid flow regime transition zones at the location based on the measured value and continuous parameter space weighting function values associated with the location and a numerical model used for describing fluid flow within the borehole.
